(19) United States
(12) Patent Application Publication
(10) Pub. No.: US 2007/0022099 A1
(43) Pub. Date: Jan. 25, 2007

(54) Question answering system, data search method, and computer program

(75) Inventors: Hiroki Yoshimura, Kanagawa (JP); Hiroshi Masuichi, Kanagawa (JP); Tomoko Ohkuma, Kanagawa (JP); Daigo Sugihara, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/312,930

(22) Filed: Dec. 21, 2005

(30) Foreign Application Priority Data
Apr. 12, 2005 (JP) 2005-114211

(51) Int. Cl. G06F 17/30

(52) U.S. Cl. 707/3

(57) ABSTRACT

A question answering system includes an answer candidate extraction unit, a query generation unit, a passage search unit, an answer candidate inspection unit and an answer output unit. The answer candidate extraction unit executes a search process based on an input question to extract a plurality of initial answer candidates. The query generation unit generates a query including at least two of the initial answer candidates as search words. The passage search unit executes a search process based on the query to extract a hit sentence corresponding to the query. The answer candidate inspection unit analyzes the hit sentence to inspect a relationship between the initial answer candidates and generates answer candidates to the input question on a basis of an inspection result. The answer output unit outputs the answer candidates generated by the answer candidate inspection unit.

### BACKGROUND OF THE INVENTION

1. Field of the Invention

This invention relates to a question answering system, a data search method, and a computer program, and more particularly to a question answering system, a data search method, and a computer program, which can provide a more precise answer to a question in a system wherein the user enters a question sentence and an answer to the question is provided.

2. Description of the Related Art

Recently, network communications through the Internet, etc., have grown in use and various services have been conducted through the network. One of the services through the network is search service. In the search service, for example, a search server receives a search request from a user terminal such as a personal computer or a mobile terminal connected to the network and executes a process responsive to the search request and transmits the processing result to the user terminal.

For example, to execute search process through the Internet, the user accesses a Web site providing search service and enters search conditions of a keyword, category, etc., in accordance with a menu presented by the Web site and transmits the search conditions to a server. The server executes a process in accordance with the search conditions and displays the processing result on the user terminal.

Data search process involves various modes. For example, a keyword-based search system wherein the user enters a keyword and list information of the documents containing the entered keyword is presented to the user, a question answering system wherein the user enters a question sentence and an answer to the question is provided, and the like are available. The question answering system is a system wherein the user need not select a keyword and can receive only the answer to the question; it is widely used.

For example, JP 2002-132811 A discloses a typical question answering system. JP 2002-132811 A discloses a question answering system configuration including a question analysis section, an information inspection section, an answer extraction section and a ground presentation section. The question analysis section determines a search word set and the question type from a question sentence presented by the user. The information inspection section extracts a passage from the search word set. The answer extraction section extracts several answer candidates from the passage. The ground presentation section presents the ground of the answer candidates.

In such a question answering system, it is not easy for the answer extraction section to precisely extract only the answer corresponding to the user question from among a large number of search results obtained from the information inspection section. Thus, the answer extraction section selects a plurality of answer candidates each having a high possibility of a right answer by calculation and presents the selected answer candidates to the user (questioner).

In the presentation process of the answer candidates, a process of presenting a sentence indicating a ground (ground sentence) for extracting each answer candidate to the user together with the answer candidate is performed. The ground presentation section performs this process. The user references the ground sentences, whereby it is made possible for the user to select a true answer from among the answer candidates.

JP 2002-132812 A also discloses the document presentation configuration of the extraction source of each answer candidate executed by the ground presentation section. Further, JP 2002-259371 A discloses an art of preparing a summary based on the importance with considering the occurrence density of words.

“An Analysis of the Ask MSR Question Answering System” (E. Brill, S. Dumais, M. Banko, Proceedings of the 2002 Conference on Empirical Methods in Natural Language Processing (2002)) discloses a configuration using a search result inspection method called tying for inspection among answer candidates. The tying is a process of making a comparison between the answer candidates obtained by searching and detecting and tying duplicate words between the answer candidates. For example, if answer candidates “ABC” and “BCD” are obtained as the answer candidates corresponding to a user question, the common words “BC” contained in the answer candidates are detected and the duplicate words are reduced to one word and the answer candidate is presented to the user as answer candidate “ABCD.”

The related arts described above are useful as arts to check one of the answer candidates obtained by searching for appropriateness. However, they do not disclose a configuration of executing process of inspecting the relationship between answer candidates to extract an appropriate answer to a user question.

In an actual question answering system, a plurality of answer candidates may appear in a passage, which includes a group of sentences obtained by a search process based on a user question. For example, assume that a user question sentence of “what is Kazuo Matsui enjoying great success in New York Mets called?” is input to a question answering system and answer candidates of “MLB,” “Baseball,” “Godzilla,” “Matsui,” and “Little” are output.

The right answer to the question is “Little' Matsui,” which is not found in the answer candidates. However, “Little” and “Matsui” are contained in the answer candidates. Several sentences such as “Kazuo Matsui was called as “Little Matsui” exist in the passage obtained by searching. However, the answer candidates selected by the question answering system of the related art “MLB,” “Baseball,” “Godzilla,” “Matsui” and “Little” do not contain “Little Matsui” of the answer required by the user.
In addition, for example, if “UMEHARA Takeshi-san to doujini bunkakunshou wo zyushoushita yonin wa daredesuka?”
(This sentence is written in Japanese language and its English translation is “Who are four recipients of the

Order of Culture at the same time as UMEHARA Takeshi?”) is input as a question sentence, for example, “AKINO Fuku,” “real name Fuku” are obtained as answer candidates. Although the basic Japanese patent application has described embodiments based on the Japanese-language question sentence, for the sake of facilitating to understand the description, the input question answers thereto, answer candidates thereto and the like will be written in English language in this embodiment. Also, it is noted that “AKINO Fuku” is written in Kanji characters in Japanese-language sentence, that “Fuku” of the real name is written in Hiragana characters and that Kanji characters and Hiragana characters are different types of characters from each other.

A sentence of “(omitted) AKINO Fuku (real name Fuku) (omitted)” in one passage really exists as a sentence indicating the relationship between “AKINO Fuku” and “real name Fuku.” Although it is desirable that “AKINO Fuku (real name Fuku)” should be contained as the answer presented to the user to the question, the answer candidates presented by the system of the related art are comparatively short clauses, and therefore presenting “AKINO Fuku” and “real name Fuku” separately as the answer candidates easily occurs.

Also, as another example, if “Who are musicians who were active in the early 20th century with Duke Ellington?” is input as a question sentence, “Louis Armstrong,” “Satchmo” may be obtained as answer candidates. A sentence of “ . . . Louis Armstrong (Satchmo) . . . ” in one passage really exists as a sentence indicating the relationship between “Louis Armstrong” and “Satchmo.” Although it is desirable that “Louis Armstrong (Satchmo)” should be contained as the answer presented to the user to the question, the answer candidates presented by the system of the related art often presents “Louis Armstrong” and “Satchmo” separately as the answer candidates.

To use tying as data processing for answer candidates, the answer candidates cannot be tied unless a part of the words making up one answer candidate is duplicate with a part of the words making up another answer candidate. In the example described above, “AKINO Fuku” and “real name Fuku” of the two answer candidates do not contain any duplicate part and if tying is executed, “AKINO Fuku (real name Fuku)” cannot be set as an answer candidate.

### SUMMARY OF THE INVENTION

As described above, if the knowledge sources to be searched, such as a database and a Web page, are searched based on a user question and the extracted passage (sentence group) contains an answer fitted to the question, the question answering system of the related art would be unable to present an appropriate answer required by the user in some cases.

The invention provides a question answering system, a data search method, and a computer program, which can improve answer accuracy by considering the relationship between the answer candidates contained in the sentences in the passage acquired by search process based on a user question.

Further, the invention can also improve the accuracy of answer candidates by paying attention to the relationship between the answer candidates and carefully examining the relationship between the answer candidates in the passage. For example, when

Question sentence: “What is an event occurring at the end of the year of 2004?”

is input to the question answering system, the information source is searched based on “2004,” “the end of the year,” and “event” of feature words contained in the question sentence, for example, and “Times Square New Year's Eve Ball” is often extracted. If an answer candidate list is generated with answer candidates ranked on a basis of the extraction frequency, and the generated list is presented to the user, a situation occurs in which “Times Square New Year's Eve Ball” is ranked in high place and “Earthquake off the Coast of Sumatra” of the right answer is ranked in low place.

The reason why such a situation occurs is that the words extracted by searching the knowledge source appear as various different words although “Sumatra Earthquake,” “Earthquake off the Coast of Sumatra,” and the like have the same meaning. If such a phenomenon occurs, the right answer to the user question is ranked in low place of the list; this is a problem.

The invention provides a question answering system, a data search method, and a computer program, which can output an appropriate answer by inspecting each answer candidate even if the answer candidate is not placed in high place of the answer candidate ranking.

According to one embodiment of the invention, a question answering system includes an answer candidate extraction unit, a query generation unit, a passage search unit, an answer candidate inspection unit and an answer output unit. The answer candidate extraction unit executes a search process based on an input question to extract a plurality of initial answer candidates. The query generation unit generates a query including at least two of the initial answer candidates as search words. The passage search unit executes a search process based on the query to extract a hit sentence corresponding to the query. The answer candidate inspection unit analyzes the hit sentence to inspect a relationship between the initial answer candidates and generates answer candidates to the input question on a basis of an inspection result. The answer output unit outputs the answer candidates generated by the answer candidate inspection unit.

According to one embodiment of the invention, a data search method includes executing a search process based on an input question to extract a plurality of initial answer candidates; generating a query including at least two of the initial answer candidates as search words; executing a search process based on the query to extract a hit sentence corresponding to the query; analyzing the hit sentence to inspect a relationship between the initial answer candidates; generating answer candidates to the input question on a basis of a result of the inspecting; and outputting the answer candidates generated.

According to one embodiment of the invention, a computer program is stored in a computer readable recording medium. The program causes a computer to execute a data search process. The data search process includes executing a search process based on an input question to extract a plurality of initial answer candidates; generating a query including at least two of the initial answer candidates as search words; executing a search process based on the query to extract a hit sentence corresponding to the query; analyzing the hit sentence to inspect a relationship between the initial answer candidates; generating answer candidates to the input question on a basis of a result of the inspecting; and outputting the answer candidates generated.

The computer program may be a computer program that can be provided by a record medium or a communication medium for providing the computer program for a computer system that can execute various program codes in a computer-readable format, for example, a record medium such as a CD, an FD, or an MO or a communication medium such as a network. Such a program is provided in the computer-readable format, whereby processing responsive to the program is realized in a computer system.

The above and other objects, features and advantages of the invention will be apparent from the following detailed description of the preferred embodiment of the invention in conjunction with the accompanying drawings. The system in the specification is a logical set made up of a plurality of units (apparatus) and is not limited to a set of units (apparatus) housed in a single cabinet.

### BRIEF DESCRIPTION OF THE DRAWINGS

In the accompanying drawings:

FIG. 1 is a drawing of the network configuration to show an application example of a question answering system of the invention;

FIG. 2 is a block diagram to describe the configuration of the question answering system according to one embodiment of the invention;

FIG. 3 is a diagram to describe a configuration example of answer candidate extraction unit in the question answering system according to the embodiment of the invention;

FIG. 4 is a drawing to show an example of a query list generated by query generation unit in the question answering system according to the embodiment of the invention;

FIG. 5 is a drawing to show an example of a query list updated by searching of passage search unit in the question answering system according to the embodiment of the invention;

FIG. 6 is a drawing to describe an example of the result of the morphological analysis generated by morphological analysis unit in the question answering system according to the embodiment of the invention;

FIG. 7 is a drawing to describe rule application process executed by answer candidate inspection unit in the question answering system according to the embodiment of the invention;

FIG. 8 is a flowchart to describe the processing sequence executed by the question answering system according to the embodiment of the invention;

FIG. 9 is a drawing to show examples of queries applied to answer candidate ranking executed by the answer candidate inspection unit in the question answering system according to the embodiment of the invention;

FIG. 10 is a flowchart to describe the processing sequence executed by the question answering system according to the embodiment of the invention;

FIG. 11 is a block diagram to show a configuration example where the answer candidate inspection unit in the question answering system according to the embodiment of the invention is changed to a machine learning technique application configuration;

FIG. 12 is a block diagram to describe a hardware configuration example of the question answering system according to the embodiment of the invention;

FIG. 13 is a drawing to show an example of a query list generated by query generation unit in the question answering system according to the embodiment;

FIG. 14 is a drawing to show an example of a query list updated by searching of passage search unit in the question answering system according to the embodiment of the invention;

FIG. 15 is a drawing to describe an example of the result of the morphological analysis generated by morphological analysis unit in the question answering system according to the embodiment of the invention;

FIG. 16 is a drawing to describe rule application process executed by answer candidate inspection unit in the question answering system according to the embodiment of the invention; and

FIG. 17 is a drawing to describe an example of the result of the morphological analysis generated by morphological analysis unit in the question answering system according to the embodiment of the invention.

### DETAILED DESCRIPTION OF EMBODIMENTS OF THE INVENTION

A question answering system, a data search method, and a computer program according to an embodiment of the invention will be discussed in detail with reference to the accompanying drawings.

### EXAMPLE

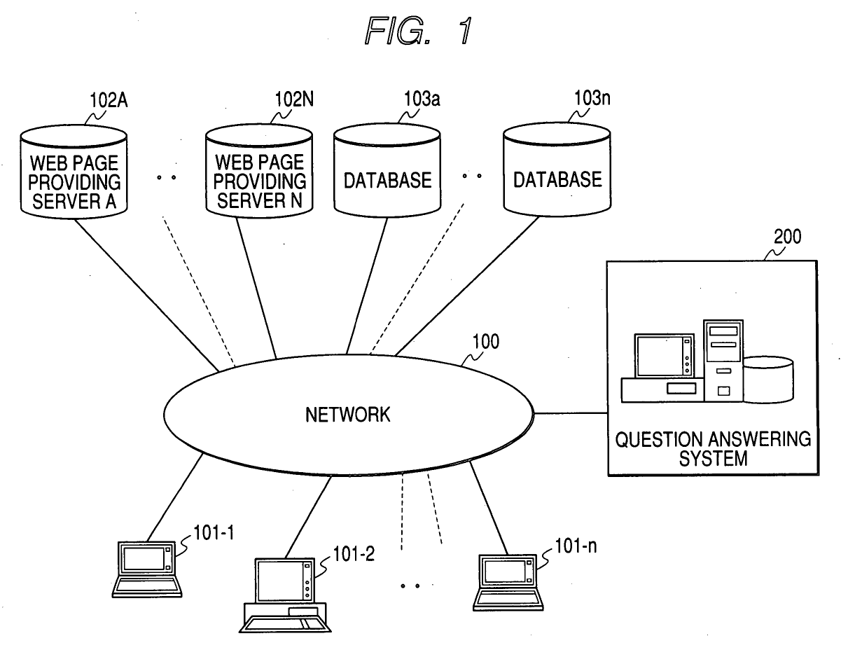

To begin with, the question answering system of one embodiment of the invention will be discussed with reference to FIG. 1. FIG. 1 is a drawing to show the network configuration wherein a question answering system 200 of this embodiment of the invention is connected to a network. A network 100 shown in FIG. 1 is a network such as the Internet, an intranet, etc. Connected to the network 100 are clients 101-1 to 101-n as user terminals for transmitting a question to the question answering system 200 and various Web page providing servers 102A to 102N for providing Web pages used as materials in acquiring answers to the clients 101-1 to 101-n and databases 103a to 103n.

The question answering system 200 inputs various question sentences generated by users from the clients 101-1 to 101-n and provides the answers to the input questions for the clients 101-1 to 101-n. The answers to the questions are acquired from the Web pages provided by the Web page providing servers 102A to 102N, document data stored in the databases 103a to 103n, and the like. The Web pages provided by the Web page providing servers 102A to 102N and the data stored in the databases 103a to 103n are data to be searched and are called knowledge sources.

The Web page providing servers 102A to 102N provide Web pages as pages opened to the public by a WWW (World Wide Web) system. The Web page is a data set displayed on a Web browser and is made up of text data, HTML layout information, an image, audio, a moving image, etc., embedded in a document. A set of Web pages is a Web site, which is made up of a top page (home page) and other Web pages linked from the top page.

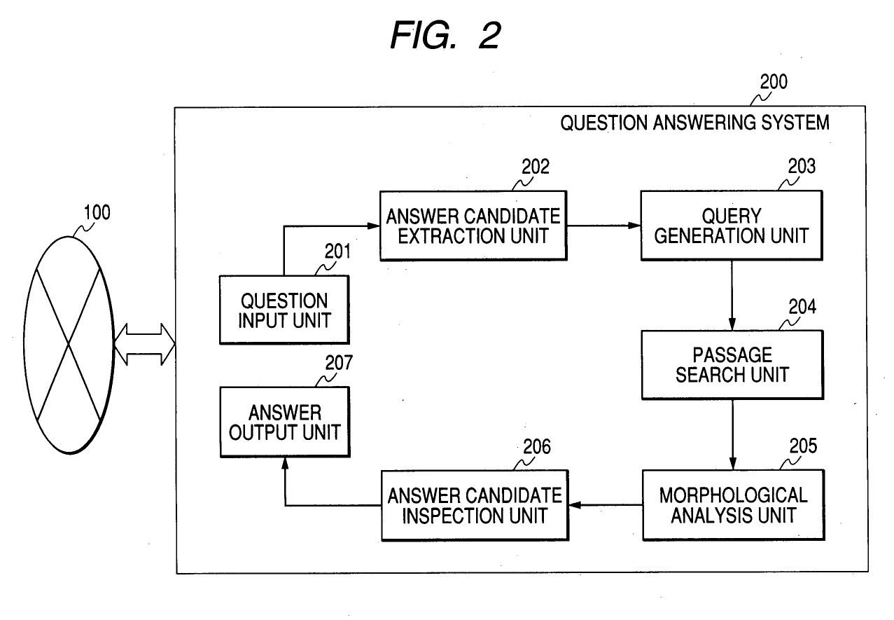

The configuration and process of the question answering system 200 will be discussed with reference to FIG. 2. The question answering system 200 is connected to the network 100 and executes a process of receiving an answer from a client connected to the network 100, searching the Web pages provided by the Web page providing servers and other databases connected to the network 100 as the knowledge sources for an answer, generating a list of answer candidates, for example, and providing the list for the client.

The configuration of the question answering system 200 of this embodiment will be discussed with reference to FIG. 2. As shown in FIG. 2, the question answering system 200 has a question input unit 201, an answer candidate extraction unit 202, a query generation unit 203, a passage search unit 204, a morphological analysis unit 205, an answer candidate inspection unit 206, and an answer output unit 207. The process executed by each unit of the question answering system 200 will be discussed below:

[Question Input Unit]

The question input unit 201 inputs a question sentence (input question) from a client through the network 100. Assuming that the following question is input from the client as a specific question example:

(input question)
“Who are four recipients of the Order of Culture at the same time as UMEHARA Takeshi?”
   The process executed by each unit of the question answering system 200 will be discussed.
   [Answer Candidate Extraction Unit]

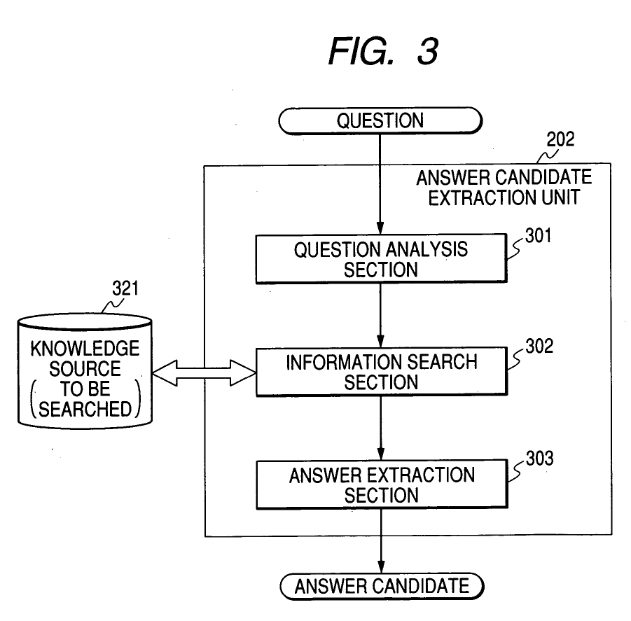

The answer candidate extraction unit 202 executes a process of searching the information source on a basis of the input question and extracting initial answer candidates like the question answering system of the related art. The process of the answer candidate extraction unit 202 will be discussed with reference to FIG. 3.

As shown in FIG. 3, the answer candidate extraction unit 202 has a question analysis section 301, an information search section 302, and an answer extraction section 303. The question analysis section 301 executes analysis process of the input question. For example, the question analysis section 301 determines the question type as to whether the answer required by the question is a person or a place or the like, and detects feature word used as a search keyword from the sentence of the input question. To perform this process, for example, the question analysis section 301 executes a syntactic and semantic analysis process. The syntactic and semantic analysis process will be discussed. Natural languages described in various languages including Japanese and English essentially have abstract and highly ambiguous nature, but can be subjected to computer processing if sentences are handled mathematically. Consequently, various applications and services concerning natural languages can be provided by automation processing, such as machine translation, an interactive system, a search system, and a question answering system. The natural language processing generally is divided into processing phases of morphological analysis, syntactic analysis, semantic analysis, and context analysis.

In the morphological analysis, a sentence is divided into words of minimal meaningful units and a certification process of part of speech is performed. In the syntactic analysis, a sentence structure of a phrase structure, etc., is analyzed based on grammar laws, etc. Since the grammar laws are of a tree structure, the syntactic analysis result generally becomes a tree structure where the words are joined based on the modification relation, etc. In the semantic analysis, a semantic structure is synthesized to find a semantic structure representing the meaning of a sentence based on the meaning (notion) of the words in the sentence, the semantic relation between the words, etc. In the context analysis, text of a series of sentences (discourse) is assumed to be the basic unit of analysis and the semantic (meaningful) unit between the sentences is obtained and a discourse structure is formed.

The syntactic analysis and the semantic analysis are absolutely necessary arts to realize applications of an interactive system, machine translation, document proofreading support, document abstract, etc., in the field of the natural language processing.

In the syntactic analysis, a natural language sentence is received and a process of determining the modification relation between the words (segments) is performed based on the grammar laws. The syntactic analysis result can be represented in the form of a tree structure called dependency structure (dependency tree). In the semantic analysis, a process of determining the case relation in a sentence can be performed based on the modification relation between the words (segments). The expression “case relation” mentioned here refers to the grammar role such as subject (SUBJ) or object (OBJ) that each of the elements making up a sentence has. The semantic analysis may contain a process of determining the sentence tense, aspect, narration, etc.

As for an example of a syntactic and semantic analysis system, a natural language processing system based on LFG is described in detail in “Constructing a practical Japanese Parser based on Lexical Functional Grammar” (Masuichi and Ohkuma, natural language processing, Vol. 10. No. 2, pp. 79-109 (2003)), “The Parallel Grammar Project” (Miriam Butt, Helge Dyvik, Tracy Holloway King, Hiroshi Masuichi, and Christian Rohrer, In Proceedings of COLING-2002 Workshop on Grammar Engineering and Evaluation, pp. 1-7, (2002)), “Lexical-Functional Grammar: A formal system for grammatical representation” (Ronald M. Kaplan and Joan Bresnan, In Joan Bresnan, editor, The Mental Representation of Grammatical Relations, TheMIT Press, Cambridge, MA, pages 173-281, (1982), Reprinted in Dalrymple, Kaplan, Maxwell, and Zaenen, editors, Formal Issues in Lexical-Functional Grammar, 29-130. Stanford: Center for the Study of Language and Information, (1995)), and US 2003/0158723 A, entire contents of which are incorporated herein by reference in its entirety. For example, the natural language processing system based on LFG can also be applied as the question analysis section 301 in the question answering system of this embodiment.

The question analysis section 301 executes the syntactic and semantic analysis process described above, for example, for the question sentence input from the user, extracts the feature word used as a search keyword, and determines the question type. The information search section 302 makes a search based on the feature word extracted by analysis of the question analysis section 301. That is, for example, the information search section 302 makes the search using the Web pages provided by the Web page providing servers connected to the network and the databases connected to the network as a knowledge source 321, and acquires a passage as a sentence group determined to contain the answer to the question.

The answer extraction section 303 executes a process of selecting answer candidates determined to be appropriate as the answer to the question from the passage as the sentence group extracted by the information search section 302.

The answer candidate extraction unit 202 executes a similar process to that of the question answering system of the related art. The system of the related art presents the answer candidates obtained at the point in time to the user as a list of the answer candidates ranked based on the occurrence frequencies, for example.

As described above, however, often the answer candidates obtained at the point in time do not contain the accurate answer to the user's question. The system of this embodiment of the invention adopts the answer candidates extracted by the answer candidate extraction unit 202 as initial answer candidates, executes the processes by the query generation unit 203, the passage search unit 204, the morphological analysis unit 205, and the answer candidate inspection unit 206 shown in FIG. 2 based on the initial answer candidates, and executes a process of generating final answer candidates presented to the user. The processes executed by the query generation unit 203, the passage search unit 204, the morphological analysis unit 205, and the answer candidate inspection unit 206 will be discussed below:

[Query Generation Unit]

The query generation unit 203 generates queries including the initial answer candidates acquired in the answer candidate extraction unit 202 as search words. For example, queries to which an n-gram technique is applied based on the initial answer candidates are generated. The n-gram technique is a technique using n adjacent characters or words as one set. In this embodiment, combinations of n answer candidates (n≧2) are enumerated. The user can also specify n.

Specific processing will be discussed. Here, it is assumed that question sentence Q is
“UMEHARA Takeshi-san to doujini bunkakunshou wo zyushoushita yonin wa daredesuka?”
(This sentence is written in Japanese language and its English translation is “Who are four recipients of the

Order of Culture at the same time as UMEHARA Takeshi?”) as described above. It is assumed that an initial answer candidate set AC (Answer Candidate) acquired in the answer candidate extraction unit 202 to the question sentence Q is

initial answer candidate set AC
{AKINO Fuku, ITO Masami, TAMURA Saburou, AGAWA Hiroyuki, real name Fuku}.
   This initial answer candidate set AC is the same as answer candidates obtained in the question answering system of the related art.

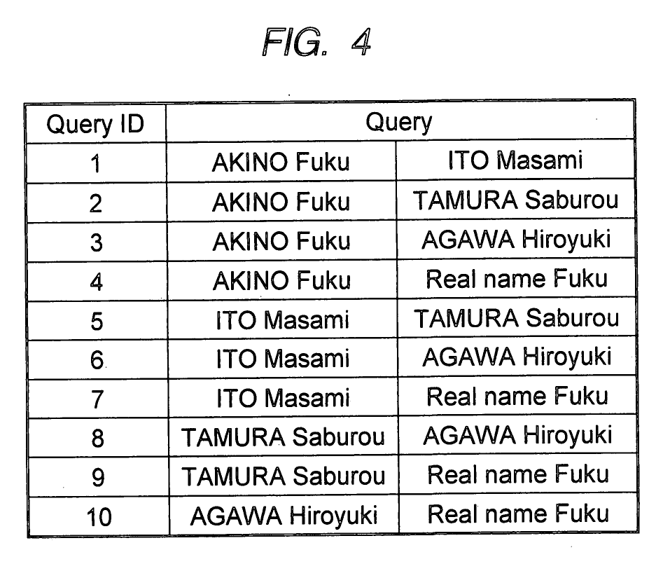

The query generation unit 203 generates a question list (query list) of combining all initial answer candidates contained in the initial answer candidate set AC {AKINO Fuku, ITO Masami, TAMURA Saburou, AGAWA Hiroyuki, real name Fuku} as search words. FIG. 4 shows an example of the query list generated by the query generation unit 203. The query list in FIG. 4 is generated based on

initial answer candidate set AC
{AKINO Fuku, ITO Masami, TAMURA Saburou, AGAWA Hiroyuki, real name Fuku}
   and includes all combinations of two initial answer candidates selected from among the initial answer candidates making up the initial answer candidate set AC {AKINO Fuku, ITO Masami, TAMURA Saburou, AGAWA Hiroyuki, real name Fuku}. This list is an example of the query list of n-gram with n=2. That is, queries of the combinations each of two search words are generated.

Since the initial answer candidate set AC {AKINO Fuku, ITO Masami, TAMURA Saburou, AGAWA Hiroyuki, real name Fuku} contains five different answer candidates, the number of combinations of two different answer candidates is (5×4)/2=10, and 10 queries are generated. That is, queries 1 to 10 are shown in FIG. 4.

Of the queries 1 to 10 shown in FIG. 4, for example, the query No. 1 means a keyword search expression such as

[AKINO Fuku and ITO Masami]. This search expression corresponds to one query.

Here, the query list example following the n-gram technique with n=2 is shown, but any desired numeric value can be set in n and all combinations that can be generated from the initial answer candidate set AC can also be generated. Since the initial answer candidate set AC in the example has five initial answer candidates, queries can be generated up to n=5, which is the maximum value of n. For example, if queries are generated based on the n-gram technique with n=3 in the initial answer candidate set AC {AKINO Fuku, ITO Masami, TAMURA Saburou, AGAWA Hiroyuki, real name Fuku} having five initial answer candidates, a query list of (5×4×3)/3!=10 queries is set. If queries are generated based on the n-gram technique with n=4, a query list of (5×4×3×2)/4!=5 queries is set.

[Passage Search Unit]

The passage search unit 204 executes a search process based on the queries generated by the query generation unit 203. The search process is applied to passages, which are of the sentence group acquired by searching the knowledge source based on the feature word extracted from the question by the information search section 302 of the answer candidate extraction unit 202. The queries generated by the query generation unit 203, namely, queries 1 to 10 shown in FIG. 4 are applied in order to the passages, for making the search.

The passage search unit 204 selects a query in order out of the query list generated by the query generation unit 203 and searches the sentence set of the passages acquired in the information search executed by the answer candidate extraction unit 202.

The sentence set of the passages is all search results, which are the sentence group containing the initial answer candidates acquired by information search of the knowledge source executed by the answer candidate extraction unit 202 based on the feature words extracted, for example, based on the following question sentence Q:
question sentence Q
“Who are four recipients of the Order of Culture at the same time as UMEHARA Takeshi?”

The passage search unit 204 executes the search process of the passages by applying the queries generated by the query generation unit 203 in order thereto.

The passage search unit 204 executes the search process by applying the ten queries shown in FIG. 4 in order
query 1 [AKINO Fuku and ITO Masami]
query 2 [AKINO Fuku and TAMURA Saburou]
query 10 [AGAWA Hiroyuki and real name Fuku]

Thus, in the search of the sentence set of the passage, only sentences containing all search words contained in each query are extracted. Further, sentence Ids, which are identifiers of the extracted sentences, are added to the query list. The sentence IDs are stored in a passage set P=(p1, p2, . . . , pi) acquired by information search of the knowledge source executed by the answer candidate extraction unit 202.

Specifically, if the passages acquired by information search of the knowledge source executed by the answer candidate extraction unit 202 are p1 to pi, passage set P is expressed as P=(p1, p2, . . . , pi) and the sentence set contained in each of the passages p1, p2, p3, . . . , pi is shown as
sentence set of passage p1={s11, s12, . . . , s1j}
sentence set of passage p2={s21, s22, . . . , s2j}
sentence set of passage pi={si1, si2, . . . , sij}.
   s11 to sij of this sentence set correspond to the sentence IDs.

If the passages acquired by information search of the knowledge source executed by the answer candidate extraction unit 202 are p1 to pi, a sentence set S contained in all passages is shown as
sentence set S={(s11, s12, . . . , s1j), . . . , (si1, si2, . . . , sij)}.

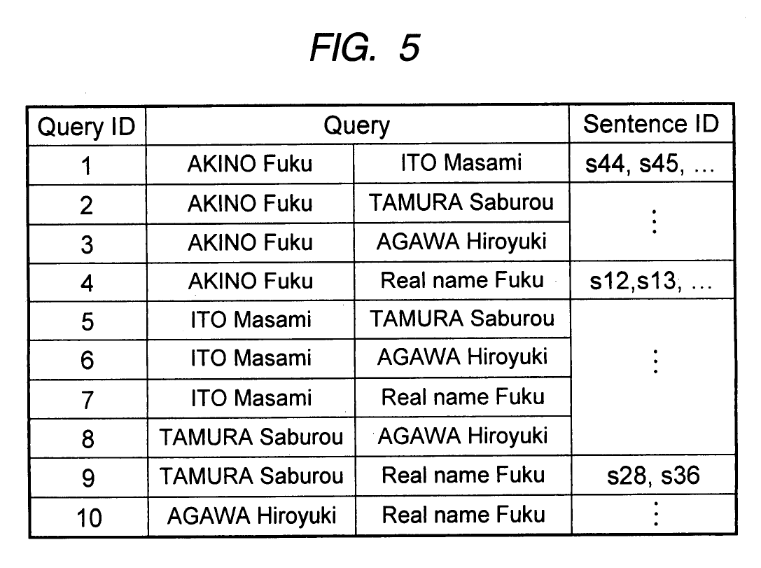

The passage search unit 204 executes a query list update process of writing the sentence IDs of hit sentences extracted as a result of the passage search process based on each query into the query list. FIG. 5 shows an example of the updated query list generated as a result of the query list update process. FIG. 5 shows some of the sentence IDs of the hit sentences extracted as a result of the passage search process based on each query executed by the passage search unit 204.

FIG. 5 shows, for example, that
statement ID=s44, s45 . . .
   are extracted as a result of passage search based on
query 1 [AKINO Fuku and ITO Masami];
statement ID=s12, s13. . .
   are extracted as a result of passage search based on
query 4 [AKINO Fuku and real name Fuku]; and
statement ID=s28, s36. . .
   are extracted as a result of passage search based on
query 9 [TAMURA Saburou and real name Fuku]
Sentence examples of sentence ID=s12 and sentence ID=s44 are as follows:

Sentence ID=s12: AKINO Fuku (real name Fuku) was born in 1908 (Meiji 41) in Ten'ryuu City, Shizuoka Prefecture.

Sentence ID=s44: This year's recipients are five of Mr. AGAWA Hiroyuki (78) of a novelist and a former naval reserve officer, Mr. AKINO Fuku (91) of a Japanese-style painter, Mr. ITO Masami (80) of a scholar of common law and constitutions and a retired Supreme Court justice, Mr. UMEHARA Takeshi (74) of a Japanese culture researcher, and Mr. TAMURA Saburou (82) of a bioorganic scholar.

The sentence ID=s12 contains “AKINO Fuku” and “real name Fuku” of search words of the query 4 [AKINO Fuku and real name Fuku] and this sentence is adopted as a hit document for query 4. The sentence ID=s44 contains “AKINO Fuku” and “ITO Masami” of search words of query 1 [AKINO Fuku and ITO Masami] and this sentence is adopted as a hit document for query 1.

The query with no hit document as a result of passage search may be deleted from the list for processing cost reduction of the computer.

[Morphological Analysis Unit]

The morphological analysis unit 205 acquires the sentence IDs of the extracted hit sentences as a result of passage search based on each query in the passage search unit 204 from the updated query list shown in FIG. 4, acquires the hit sentences corresponding to the sentence IDs, and executes morphological analysis on the acquired hit sentences.

The morphological analysis is also described previously as the process of the question analysis section 301 of the answer candidate extraction unit 202; it is processing generally executed as natural language processing and is process of dividing a sentence into words of minimal meaningful units and performing certification process of part of speech.

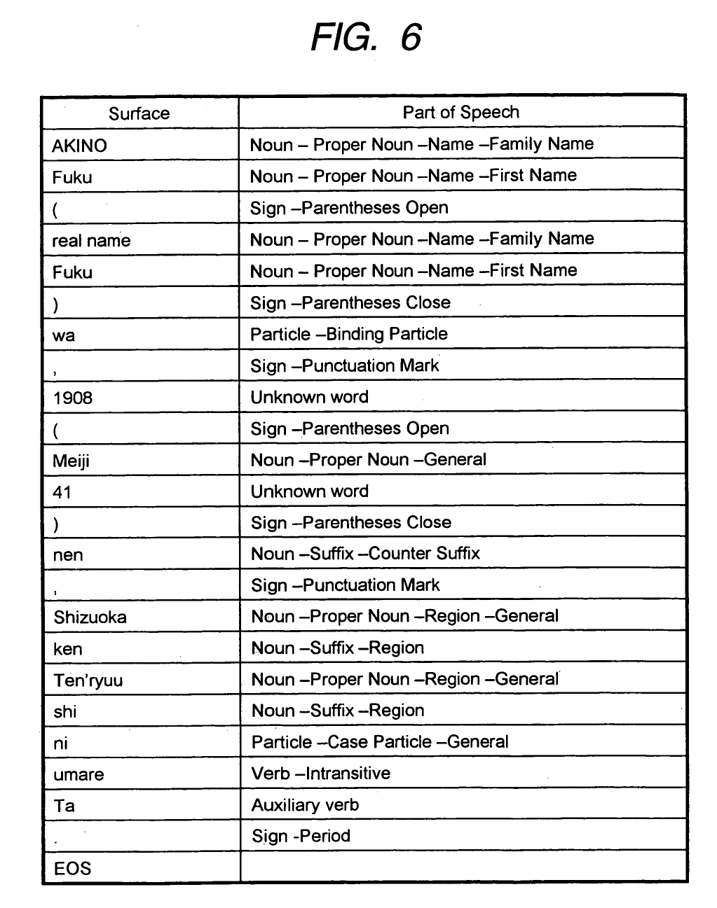

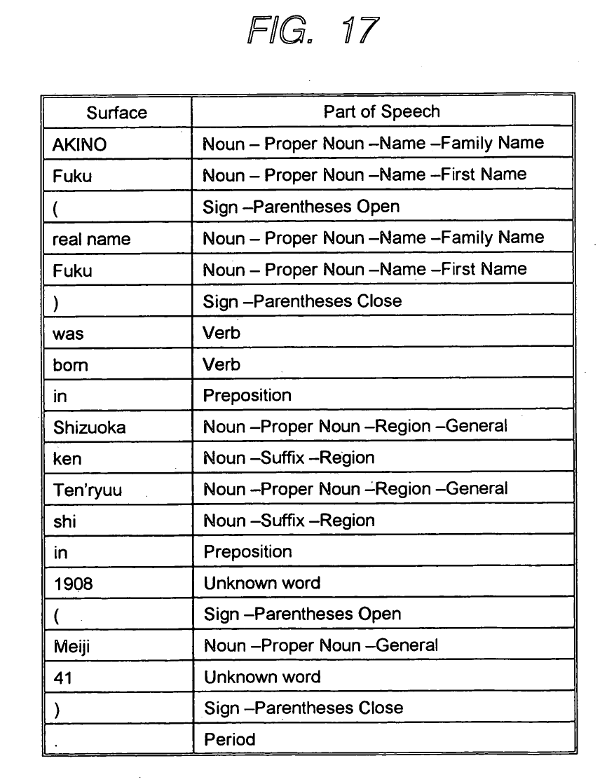

As a morphological analysis example on the hit sentence acquired by passage search, FIG. 6 shows an example of executing morphological analysis on the sentence of sentence ID=s12, which is written in Japanese language , namely,
“AKINO Fuku wa 1908 (Meiji 41) nen, Shizuoka-ken Ten'ryuu-shi ni umareta.”
(its English translation is “AKINO Fuku (real name Fuku) was born in 1908 (Meiji 41) in Ten'ryuu City, Shizuoka Prefecture.”)
   Also, FIG. 17 shows an result of the morphological analysis on the English translation of the sentence of sentence ID=s12. The result of the morphological analysis is generated as the correspondence data between [surface] as component information of the sentence and [part of speech information] of each component shown in FIG. 6.

The morphological analysis unit 205 thus executes the morphological analysis on the sentence corresponding to the extracted sentence ID as a result of passage search based on each query in the passage search unit 204, and generates the result of the morphological analysis as shown in FIG. 6.

[Answer Candidate Inspection Unit]

The answer candidate inspection unit 206 applies previously defined rules to the result of the morphological analysis generated by the morphological analysis unit 205 and inspects the relationship between the plurality of initial answer candidates extracted by the answer candidate extraction unit 202 by analyzing the hit sentence corresponding to the sentence ID selected out of the passage sentence set as a result of the passage search. For example, the answer candidate inspection unit 206 executes the inspection while applying the rules described below, determines on a basis the inspection whether or not each initial answer candidate is appropriate as an answer, and generates final answer candidates to the input question.

The rules applied in the answer candidate inspection unit 206 are the following [apposition, paraphrase, juxtaposition rules]:

Rule 1:
If the initial answer candidates are directly concatenated, they are determined a compound noun and the initial answer candidates are combined into a new answer candidate.

Rule 2:
If the initial answer candidates are directly concatenated by ADJUNCT, the initial answer candidates directly concatenated by ADJUNCT are combined into a new answer candidate.

Rule 3:
If a symbol of one character or more are sandwiched between the initial answer candidates, provided that a parenthesis, a bracket, etc., (( ), [ ], etc.,) appears after the last initial answer candidate word, the initial answer candidates are combined into a new answer candidate.

Rule 4:
If the initial answer candidates are directly concatenated by a conjunction such as “and” and “or,” the initial answer candidates are combined into a new answer candidate.

The rules applied in the answer candidate inspection unit 206 are [apposition, paraphrase, juxtaposition rules] including the rules 1 to 4. The answer candidate inspection unit 206 determines based on the result of the morphological analysis of each sentence selected as a result of passage search whether or not initial answer candidate sequence is based on (satisfying) any of the rules 1 to 4 is contained. If the initial answer candidate sequence is based on any of the rules is contained, the answer candidate inspection unit 206 combines the initial answer candidates into a new answer candidate in accordance with the rule. Specific application examples of the rules will be discussed below:

Rule 1:
If the initial answer candidates are directly concatenated, they are determined a compound noun and the initial answer candidates are combined into a new answer candidate.

If the initial answer candidates are directly concatenated, often they are a compound noun. The rule is a processing rule of combining the initial answer candidates to set them as a new answer candidate. Specifically, if the answer candidate inspection unit 206 finds the analysis portion where two initial answer candidates [Japanese] and [Red Cross Society] are directly concatenated on a basis of the result of the morphological analysis on the sentence extracted by the passage search based on a query, the answer candidate inspection unit 206 combines the two initial answer candidates [Japanese] and [Red Cross Society] and adopts [Japanese Red Cross Society] as a new answer candidate.

Rule 2:
If the initial answer candidates are directly concatenated by ADJUNCT, the initial answer candidates directly concatenated by ADJUNCT are combined into a new answer candidate.

According to this rule, when initial answer candidates A and B exist, if an analysis portion of “B of A” or “B in A” is contained in the result of the morphological analysis on the sentence selected as a result of the passage search, “B of A” or “B in A” is adopted as a new answer candidate. For example, if the answer candidate inspection unit 206 finds an analysis portion where two initial answer candidates [earthquake] and [Sumatra] are directly concatenated by ADJUNCT, namely, finds [earthquake of Sumatra] based on the result of the morphological analysis t on the sentence extracted by the passage search based on a query, the answer candidate inspection unit 206 adopts the [earthquake of Sumatra] as a new answer candidate.

Rule 3:
If a symbol of one character or more are sandwiched between the initial answer candidates, provided that a parenthesis, a bracket, etc., (( ), [ ], etc.,) appears after the last initial answer candidate word, the initial answer candidates are combined into a new answer candidate.

According to this rule, for example, when initial answer candidates A and B exist, if an analysis portion of “A (B)” is contained in the result of the morphological analysis on the sentence selected as a result of passage search, [A (B)] is adopted as a new answer candidate. For example, if the answer candidate inspection unit 206 finds that two initial answer candidates [typhoon No. 23] and [TOKAGE] are described as “typhoon No. 23 (TOKAGE)”, on a basis of the result of the morphological analysis on the sentence extracted by passage search based on a query, the answer candidate inspection unit 206 adopts the [typhoon No. 23 (TOKAGE)] as a new answer candidate.

Rule 4:
If the initial answer candidates are directly concatenated by a conjunction such as “and” and “or,” the initial answer candidates are combined into a new answer candidate.

According to this rule, for example, when initial answer candidates A and B exist, if an analysis portion of “A and B” is contained in the result of the morphological analysis on the sentence selected as a result of the passage search, [A and B] is adopted as a new answer candidate. For example, if the answer candidate inspection unit 206 finds that two initial answer candidates [rice] and [rice bran] are described as “rice and rice bran”, on a basis of the result of the morphological analysis on the sentence extracted by passage search based on a query, the answer candidate inspection unit 206 adopts the [rice and rice bran] as a new answer candidate.

The processing sequence for the above-described question, namely,

question Q:
“Who are four recipients of the Order of Culture at the same time as UMEHARA Takeshi?”
   will be discussed.

If

question Q:
“Who are four recipients of the Order of Culture at the same time as UMEHARA Takeshi?”
   is input, the answer candidate extraction unit 202 searches the knowledge source and acquires a passage including sentences containing initial answer candidates together with initial answer candidate set AC, namely,

initial answer candidate set AC=
{AKINO Fuku, ITO Masami, TAMURA Saburou, AGAWA Hiroyuki, real name Fuku}.
The query generation unit 203 generates the query list, for example, shown in FIG. 3 based on the initial answer candidate set AC {AKINO Fuku, ITO Masami, TAMURA Saburou, AGAWA Hiroyuki, real name Fuku}. The passage search unit 204 applies the queries in order to execute the passage search, and acquires hit sentences.

The morphological analysis unit 205 executes the morphological analysis on each hit document extracted by the passage search unit 204. For example, the morphological analysis unit 205 executes the morphological analysis on
Sentence ID=s12:
AKINO Fuku (real name Fuku) was born in 1908 (Meiji 41) in Ten'ryuu City, Shizuoka Prefecture.
   and obtains the result of the morphological analysis shown in FIG. 6.

Further, the answer candidate inspection unit 206 applies the above-described rules, namely, the rules 1 to 4 serving as [apposition, paraphrase, juxtaposition rules] to the result of the morphological analysis and extracts a new answer candidate.

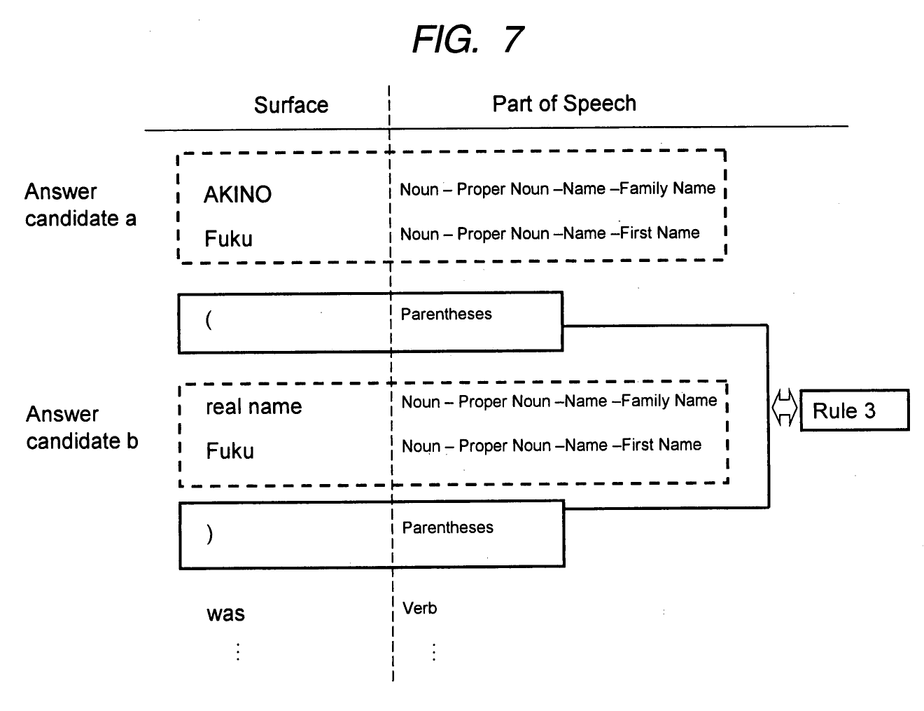

FIG. 7 shows a rule application example to the result of the morphological analysis on, for example, the sentence with sentence ID=s12, namely,
“AKINO Fuku (real name Fuku) was born in 1908 (Meiji 41) in Ten'ryuu City, Shizuoka Prefecture.”
   A description is given with reference to FIG. 7.

FIG. 7 is a drawing of extracting a part of the result of the morphological analysis shown in FIG. 6. The data contains the two initial answer candidates acquired by the answer candidate extraction unit 202, namely, [AKINO Fuku] and [real name Fuku]. Also, symbol “(” is sandwiched between the two initial answer candidates. Further, symbol “)” also appears after the word of the last answer candidate [real name Fuku]. This data form is based on (satisfies) rule 3.

Therefore, the answer candidate inspection unit 206 executes a process of selecting

[AKINO Fuku (real name Fuku)]as a new answer candidate according to

Rule 3:
If a symbol of one character or more are sandwiched between the initial answer candidates, provided that a parenthesis, a bracket, etc., (( ), [ ], etc.,) appears after the last initial answer candidate word, the initial answer candidates are combined into a new answer candidate.

The process executed by the answer candidate inspection unit 206 may change the initial answer candidates acquired by the answer candidate extraction unit 202 searching the knowledge source. The number of answer candidates provided for the user may change. A technique of setting the number of answer candidates presented to the user to the previously determined number in the question answering system, namely, predetermined value m is available. Since the answer candidate inspection unit 206 executes the processing described above, the number of answer candidates presented to the user may fall below the predetermined value m.
In the processing example described above, if question Q:

“Who are four recipients of the Order of Culture at the same time as UMEHARA Takeshi?”

is input, the answer candidate extraction unit 202 searches the knowledge source and extracts the five initial answer candidates as the initial answer candidate set AC, namely,

initial answer candidate set AC=
{AKINO Fuku, ITO Masami, TAMURA Saburou, AGAWA Hiroyuki, real name Fuku}.
   However, the processing executed by the answer candidate inspection unit 206 decreases the number of answer candidates is decreased to the four of
answer candidate set AC=
{AKINO Fuku (real name Fuku), ITOMasami, TAMURA Saburou, AGAWA Hiroyuki}.

To cope with this problem, either of the following measures is taken:

(a) Allowing Decrease in the Number of Answer Candidates

In this manner, a decrease in the number of answer candidates presented to the user to less than the predetermined value m is allowed, and the answer candidates selected in the processing executed by the answer candidate inspection unit 206 are adopted as the final answer candidates.

(b) Maintaining the Number of Answer Candidates

In this manner, processing is repeated until the number of answer candidates reaches the predetermined value m. That is, another candidate is acquired from the extracted answer candidates in the answer candidate extraction unit 202 and similar processing, namely, the query generation, passage search, morphological analysis, and answer candidate inspection process is repeated until the number of answer candidates reaches the predetermined value m.

Either of the processing techniques may be executed. In the example descried above, process of replacing the initial answer candidates extracted in the answer candidate extraction unit 202 with a new answer candidate generated in the processing executed by the answer candidate inspection unit 206, but process of adding a new answer candidate generated in the processing executed by the answer candidate inspection unit 206 to the initial answer candidates extracted in the answer candidate extraction unit 202 may be executed.

That is, if the initial answer candidates extracted in the answer candidate extraction unit 202 are
initial answer candidate set AC=
{AKINO Fuku, ITO Masami, TAMURA Saburou, AGAWA Hiroyuki, real name Fuku},
   the final answer candidates presented to the user may be
answer candidate set AC=
{AKINO Fuku (real name Fuku), ITOMasami, TAMURA Saburou, AGAWA Hiroyuki},
   but a new answer candidate may simply be added and
answer candidate set AC=
{AKINO Fuku, ITO Masami, TAMURA Saburou, AGAWA Hiroyuki, real name Fuku, AKINO Fuku (real name Fuku)}
   may be provided for the user.
   [Answer Output Unit]

The answer output unit 207 outputs the finally determined answer candidates in the answer candidate inspection unit 206 to the client.

According to the those processings, as an answer to, for example, the question Q, namely,
question Q:
“Who are four recipients of the Order of Culture at the same time as UMEHARA Takeshi?”,
   it is made possible to provide the answer candidates containing at least
answer candidate set AC=
{AKINO Fuku (real name Fuku), ITOMasami, TAMURA Saburou, AGAWA Hiroyuki} for the user.

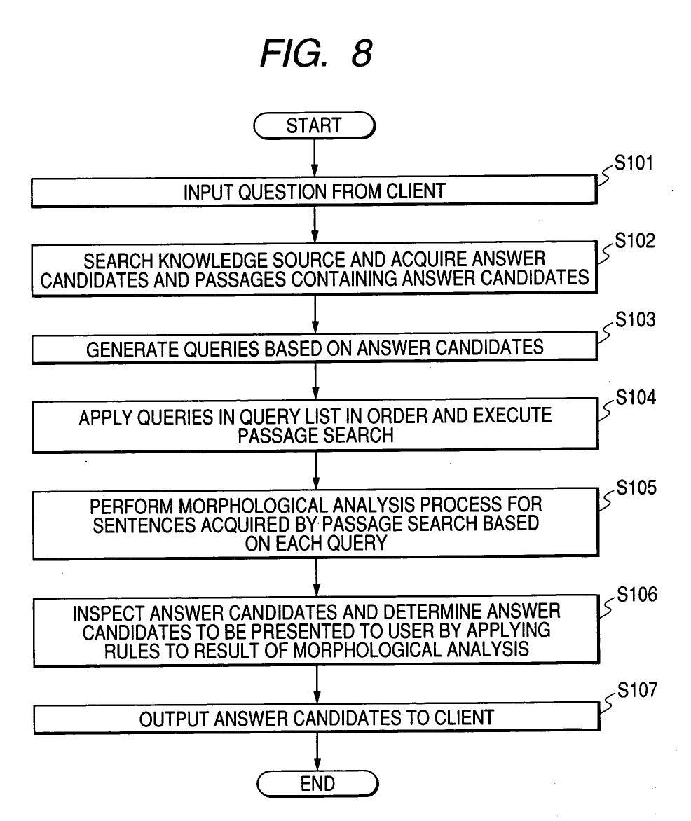

Next, the processing sequence executed by the question answering system of the invention will be discussed with reference to a flowchart of FIG. 8.

When a question from a client is input at step S101, first, the process of searching the information source based on the input question and extracting initial answer candidates is performed at step S102 as with the question answering system of the related art. The answer candidate extraction unit 202 shown in FIG. 2 executes this processing. Passages containing the sentences from which the initial answer candidates are extracted are also acquired together.

Next, at step S103, queries including the initial answer candidates acquired in the answer candidate extraction unit 202 as search words are generated. For example, queries to which the n-gram technique is applied based on the initial answer candidates are generated. The query generation unit 203 shown in FIG. 2 executes this processing; for example, the query list shown in FIG. 4 is generated.

Next, at step S104, the search process based on the queries generated by the query generation unit 203 is executed. The search process is applied to the passages as sentence groups acquired in searching the knowledge source for answer candidates. The queries generated by the query generation unit 203, namely, the queries 1 to 10 shown in FIG. 4 are applied in order for making the search, and the extracted sentence corresponding to each query is determined. The passage search unit 204 shown in FIG. 2 executes this processing.

Next, at step S105, morphological analysis on the sentences acquired by passage search based on the queries is executed the morphological analysis unit 205 shown in FIG. 2 executes this processing; for example, the result of the morphological analysis shown in FIG. 6 is obtained.

Next, at step S106, predetermined rules, namely, the [apposition, paraphrase, juxtaposition rules] including the rules 1 to 4 described above are applied to the result of the morphological analysis and the process of combining the answer candidates, etc., is performed for detecting a new answer candidate and determining the finally answer candidates. The answer candidate inspection unit 206 shown in FIG. 2 executes this processing.

Next, at step S107, the answer candidates determined by the answer candidate inspection unit 206 are provided for the client (user).

### Second Example

Next, the configuration in which in the answer candidate inspection unit 206 performs a process of adjusting the ranking of the answer candidate list provided for the user and easily sets more appropriate answer candidate ranking will be discussed as a second example of the invention.
For example, if
question sentence:
“What is an event occurring at the end of the year of 2004?”
   is input to the question answering system as described above, the information source is searched based on feature words contained in the question sentence such as “2004,” “the end of the year,” “event,” etc. and answer candidates are selected out of the sentences in the extracted passage. The selected answer candidates are listed to present the answer candidates to the user. In the listing, the answer candidates are ranked based on the frequency of appearance of each answer candidate in the passage, etc., for example.

When the information source is searched based on the feature words selected based on the question sentence such as “2004,” “the end of the year,” “event,” etc., a situation may occur in which “Times Square New Year's Eve Ball” often contained in the extracted sentences is ranked in high place and “Earthquake off the Coast of Sumatra” of the right answer is ranked in low place.

The reason why such a situation occurs is that although “Sumatra earthquake,” “Earthquake off the Coast of Sumatra Island,” and the like have the same meaning, those words extracted by searching the knowledge source appear as various different words. If such a phenomenon occurs, the right answer to the user question is ranked in low place of the list; this is a problem.

To inspect the relationship among the answer candidates in the answer candidate inspection unit 206, the question answering system according to the second example conducts inspection as to whether or not initial answer candidates contain synonymous answer candidates by calculating the word overlap ratio of the answer candidates. The question answering system can handle the answer candidates that can be handled as having the same meaning as one group, thereby generating an answer candidate list having appropriate answer ranking and presenting the list to the user. The question answering system according to the second example will be discussed.

The question answering system of the second example has the configuration shown in FIG. 2 like that in the first example previously described. That is, the question answering system 200 has the question input unit 201, the answer candidate extraction unit 202, the query generation unit 203, the passage search unit 204, the morphological analysis unit 205, the answer candidate inspection unit 206, and the answer output unit 207 as previously described with reference to FIG. 2. In the question answering system 200 of the second example, the question input unit 201, the answer candidate extraction unit 202, the query generation unit 203, and the passage search unit 204 also execute similar processing to that in the first example.

The morphological analysis unit 205 and the answer candidate inspection unit 206 execute the process of adjusting the ranking t of the answer candidates in addition to the processing described in the first example. The ranking adjustment process executed by the morphological analysis unit 205 and the answer candidate inspection unit 206 will be discussed below:

The morphological analysis unit 205 conducts the morphological analysis on the answer candidates contained in the queries generated by the query generation unit 203, and the answer candidate inspection unit 206 calculates the score of each answer candidate based on the result of the morphological analysis on each query.

In the following description, it is assumed that question sentence Q
question sentence Q:
“What is an event occurring at the end of the year of 2004?”
   is input.

For the question Q, the answer candidate extraction unit 202 searches Web pages and databases as knowledge source and obtains an initial answer candidate set AC. For example, it is assumed that
answer candidate set AC=
{“Times Square New Year's Eve Ball,” “Christmas,” . . . , “Sumatra Island Earthquake,” “Huge Earthquake off the Coast of Sumatra Island,” “Earthquake off the Coast of Sumatra”}
   is obtained.

In the system of the related art, the answer candidate set AC is presented to the user. The answer candidate set AC is presented to the user as a list arranged in the frequency of appearance order, for example.

That is, the ranking list presented to the user becomes a ranking list in the following order:

1. “Times Square New Year's Eve Ball,”

2. “Christmas,”

. . .

7 “Sumatra Island Earthquake,”

8. “Huge Earthquake off the Coast of Sumatra Island,”

9. “Earthquake off the Coast of Sumatra”

In the question answering system of the second example of the invention, the query generation unit 203 further generates queries based on the answer candidate set AC={“Times Square New Year's Eve Ball,” “Christmas,” . . . , “Sumatra Island Earthquake,” “Huge Earthquake off the Coast of Sumatra Island,” “Earthquake off the Coast of Sumatra island”}.

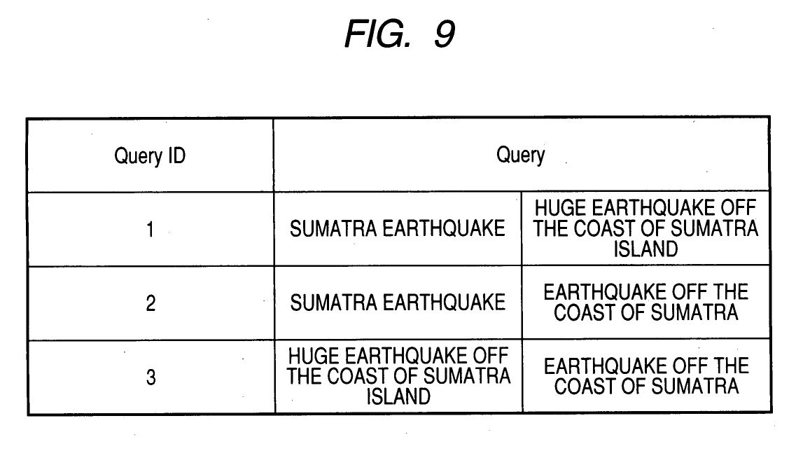

FIG. 9 shows some of queries generated by the query generation unit 203 (n-gram technique with n=2 is applied) For example, queries such as

query ID=1:
Sumatra Island Earthquake and Huge Earthquake off the Coast of Sumatra Island

query ID=2:
Sumatra Island Earthquake and Earthquake off the Coast of Sumatra

query ID=3:
Huge Earthquake off the Coast of Sumatra Island and Earthquake off the Coast of Sumatra
   are generated and the passage search unit 204 executes the passage search based on each query.

The passage search unit 204, the morphological analysis unit 205, and the answer candidate inspection unit 206 execute similar processing to that in the first example described above and generate the answer candidates to be presented to the user. In the second example, however, the following processing is further executed:

The morphological analysis unit 205 executes the morphological analysis on the answer candidate group applied to each query generated by the query generation unit 203, and the answer candidate inspection unit 206 executes a process of extracting overlap word strings from the result of the morphological analysis on the query and calculates the word overlap ratio [MR] of the answer candidates contained in the query. The word overlap ratio [MR] is represented by the following expression:

MR=
(total number of overlap words)/(total number of words of answer candidates)

In this expression, (total number of words of answer candidates) of the denominator is the total number of the word strings resulting from conducting the morphological analysis on the answer candidate strings contained in each query. As (total number of overlap words) of the numerator, the number of the overlap word strings between the answer candidates in the result of the morphological analysis on the query is counted for each answer candidate and the total number is found for each query.

If the word overlap ratio [MR] calculated according to the calculation expression mentioned above exceeds a preset threshold value [MRt], the sum total of the answer candidate scores in the answer candidates contained in the query, namely,

$${\sum }_{i} ( answer candidate\_score ) \qquad ( 1 )$$

is found.

The sum total of the answer candidate scores in the answer candidates is found based on this expression and re-ranking for the scores obtained by re-calculation is executed. It is assumed that initially ranking based on the frequency of appearance, etc., is executed as in the related art. The answer candidate score is the value generally used when the question answering system ranks the answer candidates.

The result of morphological analysis executed by the morphological analysis unit 205 on the queries shown in FIG. 9, namely,

query ID=1:
Sumatra Island Earthquake and Huge Earthquake off the Coast of Sumatra Island

query ID=2:
Sumatra Island Earthquake and Earthquake off the Coast of Sumatra

query ID=3:
Huge Earthquake off the Coast of Sumatra Island and Earthquake off the Coast of Sumatra
   will be discussed.

The answer candidates applied to the queries are the following three answer candidates:

a. [Sumatra Island Earthquake]

b. [Huge Earthquake off the Coast of Sumatra Island]

c. [Earthquake off the Coast of Sumatra]

As morphological analysis on the three answer candidates is executed, each answer candidate is divided into words.

a. [Sumatra/Island/Earthquake]=three words

b. [Huge/Earthquake/off/the/Coast/of/Sumatra/Island]=eight words

c. [Earthquake/off/the/Coast/of/Sumatra]=six words

Thus, the number of words of each answer candidate is found. The mark “/” indicates separation of the words.

The answer candidate inspection unit 206 executes a process of extracting overlap word strings from the result of the morphological analysis on the query and calculates the word overlap ratio [MR] of the answer candidates contained in the query. The word overlap ratio [MR] is represented by the following expression as described above:

MR=
(total number of overlap words)/(total number of words of answer candidates)

The word overlap ratio [MR] of each query is found as follows:
query ID 1: MR=(3+3)/(3+8)=6/11=0.55
query ID 2: MR=(3+3)/(3+6)=6/9=0.67
query ID 3: MR=(6+6)/(8+6)=7/9=0.86

If the determination criterion as to whether or not the answer candidates are synonymous is set to threshold value MRt=0.50, the word overlap ratio [MR] of each of query ID 1, query ID 2, and query ID 3 is greater than threshold value MRt=0.50 and the result satisfies the execution criterion of a re-ranking process.

In this case, the answer candidate inspection unit 206 uses the answer candidate score set for each answer candidate by formerly known score calculation method such as frequency of appearance to again calculate the scores.

Now, assume that the answer candidates have the following calculation values as the calculation scores based on the former score calculation process:

“Sumatra Island Earthquake”:1.23

“Huge Earthquake off the Coast-of Sumatra Island”:0.98

“Earthquake off the Coast of Sumatra”:0.33

The answer candidate inspection unit 206 inputs the scores, handles the synonymous answer candidates as one group, and performs the score re-calculation process. Specific process is described as follows:

“Sumatra Island Earthquake”+“Huge Earthquake off the Coast of Sumatra Island”=1.23+0.98=2.21

“Sumatra Island Earthquake”+“Earthquake off the Coast of Sumatra”=1.23+0.33=1.56

“Huge Earthquake off the Coast of Sumatra Island”+“Earthquake off the Coast of Sumatra”=0.98+0.33=1.31

Since re-calculation is performed, the following answer candidate set nAC is set as a new ranked answer candidate set:

answer candidate set nAC=
{“Sumatra Island Earthquake”+“Huge Earthquake off the Coast of Sumatra Island,” “Times Square New Year's Eve Ball,” “Christmas,” . . . , “Sumatra Island Earthquake”+“Earthquake off the Coast of Sumatra,” “Huge Earthquake off the Coast of Sumatra Island”+“Earthquake off the Coast of Sumatra”}.

The answer candidate list before the re-ranking is the ranking list in the following order:

1. “Times Square New Year's Eve Ball,”

2. “Christmas,”

. . .

7 “Sumatra Island Earthquake,”

8. “Huge Earthquake off the Coast of Sumatra Island,”

9. “Earthquake off the Coast of Sumatra”

In the system of the second example of the invention, the answer candidate inspection unit 206 re-calculates the scores to again set the ranking and consequently, the answer candidate set nAC={“Sumatra Island Earthquake”+“Huge Earthquake off the Coast of Sumatra Island,” “Times Square New Year's Eve Ball,” “Christmas,” . . . , “Sumatra Island Earthquake”+“Earthquake off the Coast of Sumatra,” “Huge Earthquake off the Coast of Sumatra Island”+“Earthquake off the Coast of Sumatra”} is acquired and the ranking list to be presented to the user becomes as follows:

1. “Sumatra Island Earthquake”+“Huge Earthquake off the Coast of Sumatra Island,”

2. “Times Square New Year's Eve Ball,”

3. “Christmas,”
. . . ,

8. “Sumatra Island Earthquake”+“Earthquake off the Coast of Sumatra,”

9. “Huge Earthquake off the Coast of Sumatra Island”+“Earthquake off the Coast of Sumatra”

It is made possible to generate and present the optimum answer candidate list containing “Sumatra Island Earthquake” +“Huge Earthquake off the Coast of Sumatra Island” in the first entry, as the optimum answer to the question sentence: “What is an event occurring at the end of the year of 2004?”. If the value of n of the n-gram technique is increased, other highly relating answer candidates can be ranked in high place. In the example, if n is set to 3, it is made possible to present “Earthquake off the Coast of Sumatra” of another answer candidate highly relating to “Sumatra Island Earthquake”+“Huge Earthquake off the Coast of Sumatra Island” in high place of the answer candidate ranking like “Sumatra Island Earthquake”+“Huge Earthquake off the Coast of Sumatra Island” +“Earthquake off the Coast of Sumatra.” With regard to the combined answer candidates, all answer candidates can also be combined for output, but one answer candidate may be output. Specifically, “Sumatra Island Earthquake” or “Huge Earthquake off the Coast of Sumatra Island” whichever is higher in the score, can also be output instead of outputting “Sumatra Island Earthquake”+“Huge Earthquake off the Coast of Sumatra Island.”

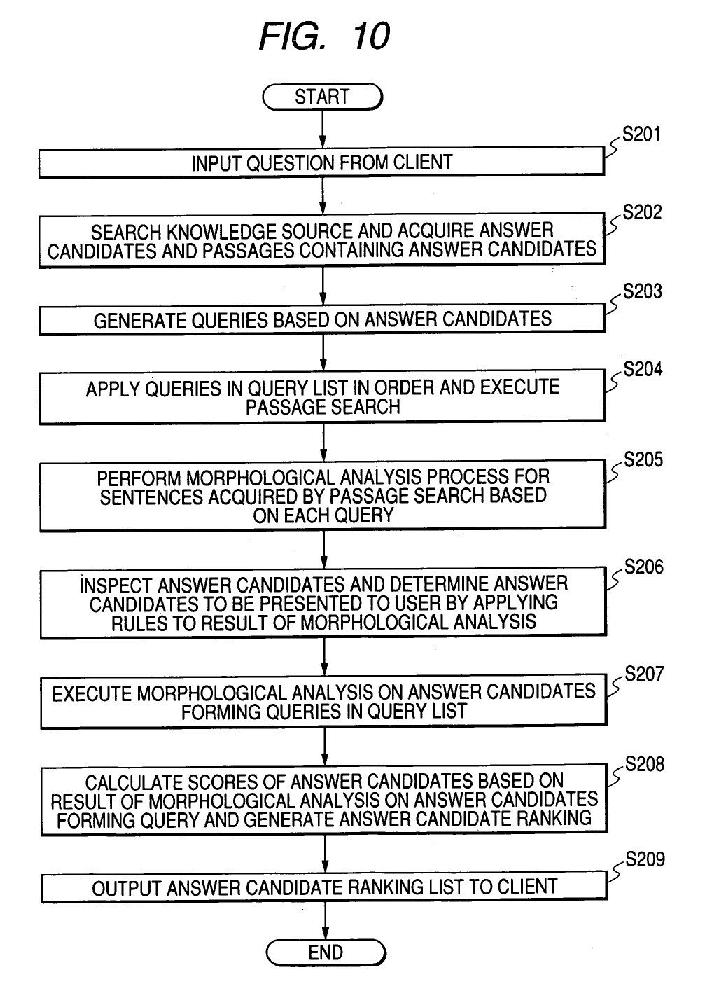

Next, the process sequence executed by the question answering system of the second example will be discussed with reference to a flowchart of FIG. 10.

Steps S201 to S206 are similar to steps S101 to S106 of the flowchart of FIG. 8 previously described in the first example. At step S201, a question from a client is input; at step S202, the process of searching the information source based on the input question and extracting initial answer candidates is performed; at step S203, queries including the acquired initial answer candidates as search words are generated; at step S204, passage search based on the generated queries is executed, at step S205, the morphological analysis on the sentences acquired by passage search is executed; and at step S206, the predetermined rules, namely, the [apposition, paraphrase, juxtaposition rules] including the rules 1 to 4 described above are applied to the result of the morphological analysis and the process of combining the answer candidates, etc., is performed for determining the final answer candidates.

In the second example, further, at step S207, the morphological analysis on the answer candidates, which are the components of the queries generated at step S203, is executed. The morphological analysis unit 205 executes this process.

Further, at step S208, the word overlap ratio [MR] of each query is calculated based on the result of the morphological analysis on the query. If the answer candidate has the word overlap ratio [MR] higher than the predetermined threshold value [MRt], it is determined that the answer candidates are a synonymous answer slightly different in expression, the score re-calculation process of the answer candidate is executed, and answer candidate ranking based on the re-calculated score is generated. The answer candidate inspection unit 206 shown in FIG. 2 executes this process.

Next, at step 209, the answer candidate ranking list determined by the answer candidate inspection unit 206 is provided for the client (user).

### Other Examples

Next, other examples of the question answering system according to the invention will be discussed.

(1) Modification Example of Objects to be Searched by Passage Search Unit

In the examples described above, the objects to be searched by the passage search unit 204 shown in FIG. 2 are passages, which are sentence groups, each made up of sentences containing answer candidates extracted when the answer candidate extraction unit 202 searches the knowledge source as the search object for the answer candidates.

The passage search unit 204 shown in FIG. 2 need not necessarily search such limited search objects and may search a new knowledge source different from the knowledge source searched by the answer candidate extraction unit 202, such as a database accumulating data only in a specific field, for example.

The search object category may be determined according to the answer candidates obtained as a result of search by the answer candidate extraction unit 202 and search may be narrowed down to a specialized database, Web page, etc., accumulating the data relevant to the answer candidates determined based on the answer candidates.

Such a configuration is adopted, whereby the possibility that new search data may be able to be found from any other than the knowledge source searched by the answer candidate extraction unit 202 is raised, and it is made possible to raise the possibility that an answer to a question may be able to be obtained.

(2) Process Executed by Answer Candidate Inspection Unit

In the examples described above, to inspect the relationship between the initial answer candidates, the answer candidate inspection unit 206 applies the predetermined rules, namely, the [apposition, paraphrase, juxtaposition rules] including the rules 1 to 4 described above and executes the process of combining the answer candidates, to thereby determine the final answer candidates.

The answer candidate inspection unit 206 may execute a process of conducting re-inspection as to whether or not the new answer candidate generated by executing such answer candidate combining process is appropriate as an answer candidate.

The already combined answer candidate newly generated by the answer candidate inspection unit 206 is referred to as a combined answer candidate (cAC).

The answer candidate inspection unit 206 again inputs the generated combined answer candidate (cAC) to the answer candidate extraction unit 202, which then searches the knowledge source based on the combined answer candidate (cAC) Here, if it is confirmed that the same term as the combined answer candidate (cAC) exists in the knowledge source, the combined answer candidate (cAC) is contained in the answer candidates to be provided for the user as a valid answer candidate. If it is not confirmed that the same term as the combined answer candidate (cAC) exists in the knowledge source, the combined answer candidate (cAC) is deleted from the answer candidates to be provided for the user as an invalid answer candidate.

A knowledge source different from the previously applied knowledge source may be applied to the search process based on the combined answer candidate (cAC).

Such answer candidate re-inspection process is performed, whereby it is made possible to re-check whether or not the combined answer candidate (cAC) generated by the answer candidate inspection unit 206 is appropriate as the answer candidates to be provided for the user, and it is made possible to prevent an erroneous answer candidate from being presented to the user.

(3) Skipping of Process Executed by Morphological Analysis Unit

In the examples described above, the morphological analysis unit 205 executes the morphological analysis on the sentences acquired by passage search and generates the result of the morphological analysis, for example, shown in FIG. 6, and the answer candidate inspection unit 206 determines whether or not the answer candidates are based on the rule, based on the result of the morphological analysis.

The answer candidate inspection unit 206 may determine whether or not each sentence acquired by the passage search is based on rules without executing the morphological analysis. For example, a component part based on rule is detected based on the fact that the sentence acquired by passage search corresponds to a pattern indicating the rule.

For example, it is assumed that the question answering system inputs the question sentence Q and outputs the answer candidate set AC and search result sentence s12 is obtained as the search result of the passage search unit.

Question Q:
Who are four recipients of the Order of Culture at the same time as UMEHARA Takeshi?

answer candidate set AC:
AKINO Fuku, ITO Masami, TAMURA Saburou, AGAWA Hiroyuki, real name Fuku

search result sentence s12:
AKINO Fuku (real name Fuku) was born in 1908 (Meiji 41) in Ten'ryuu City, Shizuoka Prefecture.

Pattern matching is executed for the search result sentence s12 to check where each answer candidate in the answer candidate set AC is contained and what character exists between the answer candidates.

For example, assuming that

search words:
AKINO Fuku, ITO Masami, TAMURA Saburou, AGAWA Hiroyuki, real name Fuku,
   s12 contains the two search words “AKINO Fuku” and “real name Fuku” and [AKINO Fuku (real name Fuku)] is extracted as the pattern matching result.

Determination as to whether or not the answer candidates are to be combined conforms to the apposition, paraphrase, juxtaposition rules as in the examples described above. However, since the morphological analysis is not conducted, the determination is made according to pattern matching rules. The rules are set, for example, as follows:

1. The answer candidates are directly concatenated.

2. “or,” “to,” “and,” “of,” “in,” “at,” etc., is sandwiched between the answer candidates.

3. A parenthesis or a bracket (( ), [ ], etc.,) exists between the answer candidates. One answer candidate is enclosed in parentheses.

In the example described above, AKINO Fuku (real name Fuku) is found as a result of the pattern matching and a parenthesis “(” exists between the answer candidates. Therefore, the answer candidates are combined and the similar result to that produced by rule application based on the morphological analysis can be obtained.

In the process example, the pattern matching process rather than morphological analysis process is performed, so that it is made possible to skip the morphological analysis process, and the processing speed is increased.

(4) Modification Example of Process Executed by Answer Candidate Inspection Unit

In the examples described above, the answer candidate inspection unit 206 executes the process of determining the possibility of applying the predetermined rules, namely, the apposition, paraphrase, juxtaposition rules to the result of the morphological analysis generated by the morphological analysis unit 205 and determining the possibility of combining the answer candidates.

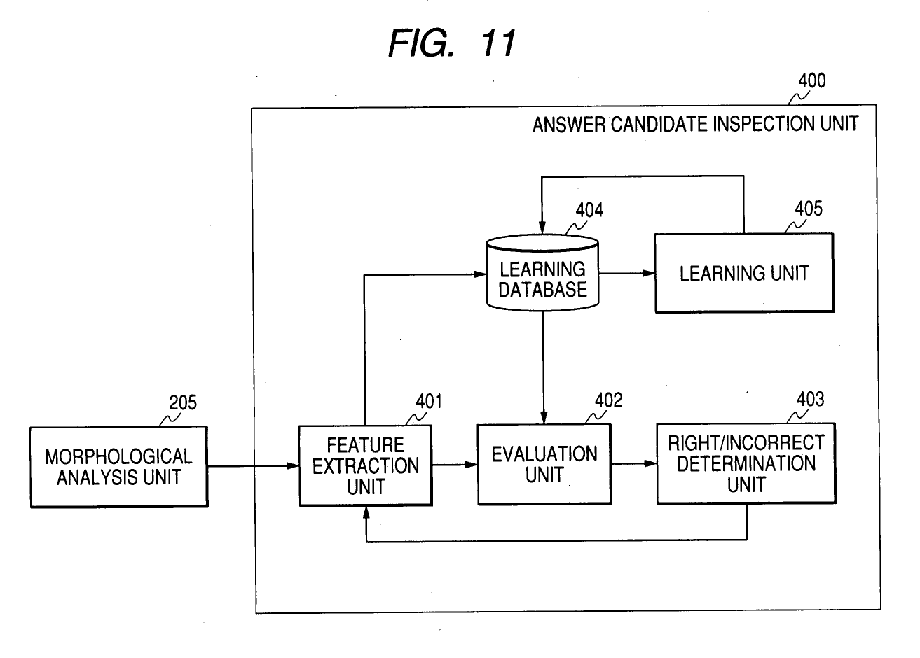

In the process, the apposition, paraphrase, juxtaposition rules need to be preset and only the fixed rules are applied. The rules are placed in a rule generation process configuration to which a machine learning technique is applied, whereby update of the rules, etc., is made possible. FIG. 11 shows a configuration example of answer candidate inspection unit 400 to which the machine learning technique is applied.

A feature extraction unit 401 extracts machine learning data (feature) from the result of the morphological analysis retained by the morphological analysis unit 205, such as part of speech, the distance between clauses, etc. A evaluation unit 402 evaluates the feature retained by the feature extraction unit 401 based on previously collected machine learning data (feature) using Support Vector Machine (SVM), one of the machine learning techniques. In other words, the evaluation unit 402 determines whether or not the answer candidates have any relationship therebetween. The SVM is a machine learning technique of categorizing the features into right answers (positive examples) and incorrect answers (negative examples) and determining whether the input data is a positive example or a negative example. The SVM is described in detail in document “Fabrizio Sebaastiani, Machine Learning in Automated Text Categorization, ACM Computing Surveys Vol. 34, No. 1, pp. 1-47, 2002” and references cited in this article.

A learning database 404 stores feature data. Right/incorrect determination unit 403 allows a user to determine whether or not the answer candidate set retained by the evaluation unit 402 is a right answer. At this time, the original of the passage is presented together as the ground text. A learning unit 405 constructs a learning model used in evaluation of the SVM and storing the learning model in a learning DB when the feature extraction unit 401 stores new learning data. Information concerning positive or negative example required for the composition of the learning data is information concerning the right or incorrect answer for the answer candidate given by the user, retained by the right/incorrect determination unit 403.

The process sequence of the answer candidate inspection unit to which the machine learning technique as shown in FIG. 11 is applied as the answer candidate inspection unit is as follows:

Step 1.

The feature extraction unit 401 adopts part of speech information of the answer candidates, the distance between the clauses between the answer candidates, enumeration of parts of speech between the answer candidates, etc., of the sentences containing the query (answer candidates) in the passage retained by the morphological analysis unit 205 as features.

Step 2.

The evaluation unit 402 uses the feature and the SVM to determine whether or not the answer candidates of the query generated by the query generation unit 203 have the relationship to allow the answer candidates to be combined. The answer candidates determined the right example as a result are combined. To combine the answer candidates, the word existing between the answer candidates is also presented. For example, if “Little” and “Matsui” are successively appeared, “Little Matsui” is presented.

Step 3.

The right/incorrect determination unit 403 allows the user to check whether or not the answer is a right answer for every answer candidate in the answer candidate set. For the answer candidate set, the ground sentence (sentence in the passage containing the answer candidate) is presented together for each answer candidate. The ground sentence also has the sentence ID and the result of the morphological analysis as other data pieces.

Step 4.

The feature extraction unit 401 extracts the feature from the result of the morphological analysis of the ground sentence of each answer candidate. Information concerning the positive or negative example required for the learning data is the result of the right or incorrect answer determination given by the user.

Step 5.

The feature extracted by the feature extraction unit 401 is stored in the learning database 404.

Step 6.

The features stored so far in the learning database 404 and the added feature created at the processing step are used together to again compose the learning model.

Step 7.

A new learning model is stored in the learning database 404. The stored learning model is used for later evaluation.

Whenever a new question is input to the question answering system, the processing is repeated. The learning model is always updated. As the machine learning technique application configuration is thus adopted for the answer candidate inspection unit, the need for previously creating large rules is eliminated and the cost is suppressed. Also in a pattern between answer candidates not fitted for the rules, it may be determined that the answer candidates have the relationship according to the result of the machine learning technique, and the accuracy of the answer candidates can be improved.

In the examples described above, to conduct inspection as to whether or not initial answer candidates contain synonymous answer candidates and handle the answer candidates as having the same meaning based on the inspection as one group, the answer candidate inspection unit 206 calculates the word overlap ratio [MR] of each query and determines that the answer candidate is a synonymous answer slightly different in expression. However, the invention is not limited thereto. As the determination technique as to whether or not the initial answer candidates are synonymous, a synonym dictionary may be provided and a search is made for the whole answer candidate or the word of a part thereof and the answer candidates that can be handled as synonyms are handled as one group; as a more simple technique, the answer candidates, which become identical with each other if a preposition is excluded from the answer candidate are handled as one group; the answer candidates, which become identical with each other if conjunction “and” is excluded and the preceding and following words are concatenated by a hyphen are handled as one group (for example, if software name become an answer to a question, for example, initial letters of the words “Operating” and “System” are picked up and “OS” is also handled as a synonym); and further process of integrating fluctuations of description is performed (“flower” is handled as having the same meaning as “flowers,” “Flower,” or “FLOWER”), whereby inspection can also be conducted.

### Example 1

An example where question sentence Q
“Who are musicians who were active in the early 20th century with Duke Ellington?”
   is input to the question answering system 200 shown in FIG. 2 will be described below.

It is assumed that an initial answer candidate set AC (Answer Candidate) acquired in the answer candidate extraction unit 202 to the question sentence Q is

initial answer candidate set AC
{Louis Armstrong, Count Basie, Benny Goodman, Ella Fitzgerald, Satchmo}.
   This initial answer candidate set AC is the same as answer candidates obtained in the question answering system of the related art.

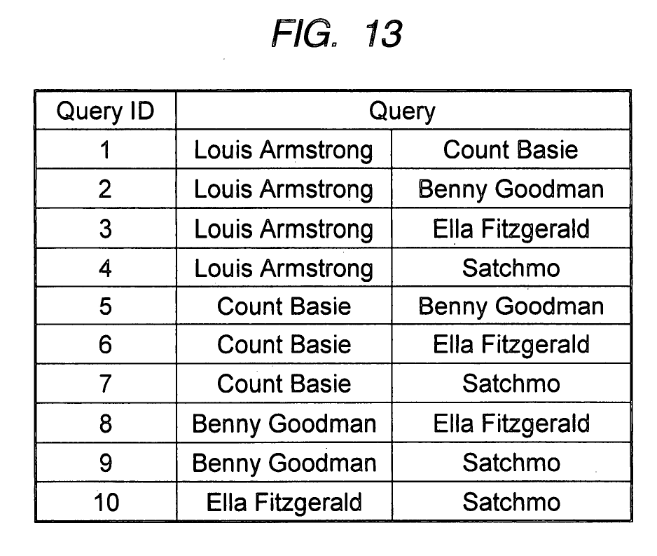

The query generation unit 203 generates a question list (query list) of combining all initial answer candidates contained in the initial answer candidate set AC {Louis Armstrong, Count Basie, Benny Goodman, Ella Fitzgerald, Satchmo} as search words. FIG. 13 shows the query list generated by the query generation unit 203 with n=2. It is noted that desirable numeral number can be set in n as described above.

Then, the passage search unit 204 executes the search process of the passages, which are of the sentence group acquired by searching the knowledge source based on the feature word extracted from the question by the information search section 302 of the answer candidate extraction unit 202, by applying the queries generated by the query generation unit 203 in order thereto.

The passage search unit 204 executes the search process by applying the ten queries shown in FIG. 13 in order
query 1 [Louis Armstrong and Count Basie]
query 2 [Louis Armstrong and Benny Goodman]

. . .
query 10 [Ella Fitzgerald and Satchmo]

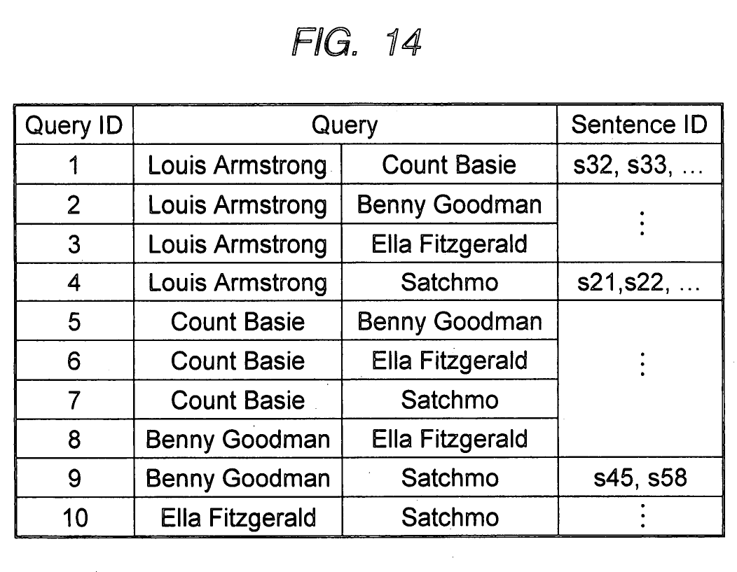

The passage search unit 204 executes the query list update process of writing the sentence IDs of hit sentences extracted as a result of the passage search process based on each query into the query list. FIG. 14 shows the updated query list generated as a result of the query list update process. FIG. 14 shows some of the sentence IDs of the hit sentences extracted as a result of the passage search process based on each query executed by the passage search unit 204.

Sentence examples of sentence ID=s21 and sentence ID=s32 are as follows:

Sentence ID=s21: Louis Armstrong (Satchmo) was born in New Orleans in 1901.

Sentence ID=s32: The recipients were five of Ella Fitzgerald of a female vocal, Louis Armstrong of a trumpet player, Count Basie of a piano player, Duke Ellington of a pianist and Benny Goodman of an saxophone player.

The sentence ID=s21 contains “Louis Armstrong” and “Satchmo” of search words of the query 4 [Louis Armstrong and Satchmo] and this sentence is adopted as a hit document for query 4. The sentence ID=s32 contains “Louis Armstrong” and “Count Basie” of search words of query 1 [Louis Armstrong and Count Basie] and this sentence is adopted as a hit document for query 1.

The morphological analysis unit 205 acquires the sentence IDs of the extracted hit sentences as a result of passage search based on each query in the passage search unit 204 from the updated query list shown in FIG. 14, acquires the hit sentences corresponding to the sentence IDs, and executes morphological analysis on the acquired hit sentences.

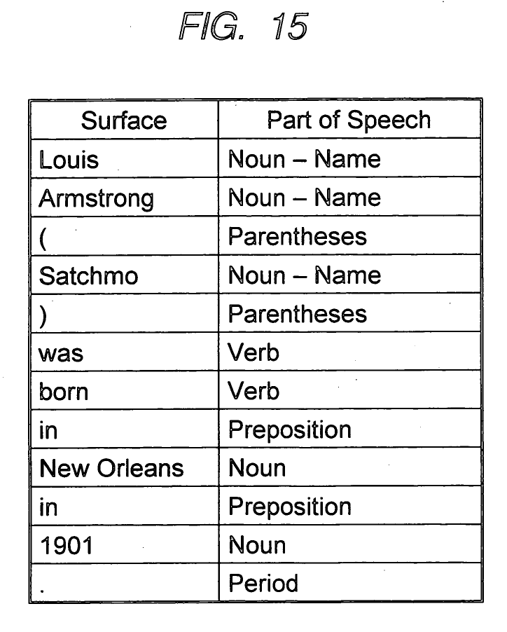

As a morphological analysis example on the hit sentence acquired by passage search, FIG. 15 shows a result of executing morphological analysis on the sentence of sentence ID=s21 described above, namely,
“Louis Armstrong (Satchmo) was born in New Orleans in 1901.”

Further, the answer candidate inspection unit 206 applies the above-described rules, namely, the rules 1 to 4 serving as [apposition, paraphrase, juxtaposition rules] to the result of the morphological analysis and extracts a new answer candidate.

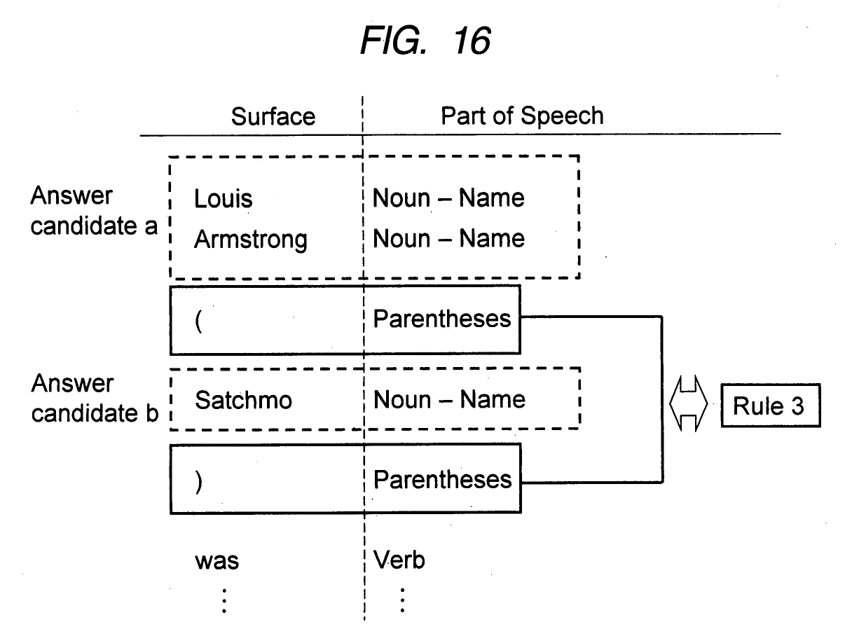

FIG. 16 shows a rule application to the result of the morphological analysis on, for example, the sentence with sentence ID=s21, namely,
“Louis Armstrong (Satchmo) was born in New Orleans in 1901.”
   A description is given with reference to FIG. 16.

FIG. 16 is a drawing of extracting a part of the result of the morphological analysis shown in FIG. 15. The data contains the two initial answer candidates acquired by the answer candidate extraction unit 202, namely, [Louis Armstrong] and [Satchmo] . Also, symbol “(” is sandwiched between the two initial answer candidates. Further, symbol “)” also appears after the word of the last answer candidate [Satchmo] . This data form is based on rule 3.

Therefore, the answer candidate inspection unit 206 executes a process of selecting
[Louis Armstrong (Satchmo)]
   as a new answer candidate according to rule 3.

The process executed by the answer candidate inspection unit 206 may change the initial answer candidates acquired by the answer candidate extraction unit 202 searching the knowledge source. The number of answer candidates provided for the user may change. A technique of setting the number of answer candidates presented to the user to the previously determined number in the question answering system, namely, predetermined value m is available. Since the answer candidate inspection unit 206 executes the processing described above, the number of answer candidates presented to the user may fall below the predetermined value m.
In the processing example described above, if question Q:
“Who are musicians who were active in the early 20th century with Duke Ellington?”
   is input, the answer candidate extraction unit 202 searches the knowledge source and extracts the five initial answer candidates as the initial answer candidate set AC, namely,

initial answer candidate set AC=
{Louis Armstrong, Count Basie, Benny Goodman, Ella Fitzgerald, Satchmo}.
   However, the processing executed by the answer candidate inspection unit 206 decreases the number of answer candidates is decreased to the four of

answer candidate set AC=
{Louis Armstrong (Satchmo), Count Basie, Benny Goodman, Ella Fitzgerald}.

To cope with this problem, either of (a) allowing decrease in the number of answer candidates or (b) maintaining the number of answer candidates may be take as described above.

That is, if the initial answer candidates extracted in the answer candidate extraction unit 202 are

initial answer candidate set AC=
{Louis Armstrong, Count Basie, Benny Goodman, Ella Fitzgerald, Satchmo},
   the final answer candidates presented to the user may be

answer candidate set AC=
{Louis Armstrong (Satchmo), Count Basie, Benny Goodman, Ella Fitzgerald},
   but a new answer candidate may simply be added and

answer candidate set AC=
{Louis Armstrong, Count Basie, Benny Goodman, Ella Fitzgerald, Satchmo, Louis Armstrong (Satchmo)}
   may be provided for the user.

The answer output unit 207 outputs the finally determined answer candidates in the answer candidate inspection unit 206 to the client.

According to the those processings, as an answer to, for example, the question Q, namely,

question Q:
“Who are musicians who were active in the early 20th century with Duke Ellington?”,
   it is made possible to provide the answer candidates containing at least

answer candidate set AC=
{Louis Armstrong (Satchmo), Count Basie, Benny Goodman, Ella Fitzgerald}
   for the user.

As described above, the answer candidate inspection unit 206 may determine whether or not each sentence acquired by the passage search is based on rules without executing the morphological analysis.

For example, the answer candidate inspection unit 206 may execute pattern matching for the search result sentence s21:
“Louis Armstrong (Satchmo) was born in New Orleans in 1901.”
   to check where each answer candidate in the answer candidate set AC is contained and what character exists between the answer candidates.

It is assumed that

search words:
Louis Armstrong, Count Basie, Benny Goodman, Ella Fitzgerald, Satchmo
   s12 contains the two search words “Louis Armstrong” and “Satchmo” and [Louis Armstrong (Satchmo)] is extracted as the pattern matching result.

Determination as to whether or not the answer candidates are to be combined conforms to the apposition, paraphrase, juxtaposition rules as in the examples described above. However, since the morphological analysis is not conducted, the determination is made according to pattern matching rules. The rules are set, for example, as follows:

1. The answer candidates are directly concatenated.

2. “or,” “to,” “and,” “of,” “in,” “at,” etc., is sandwiched between the answer candidates.

3. A parenthesis or a bracket (( ), [ ], etc.,) exists between the answer candidates. One answer candidate is enclosed in parentheses.

In this example, “Louis Armstrong (Satchmo)” is found as a result of the pattern matching and a parenthesis “(” exists between the answer candidates. Therefore, the answer candidates are combined and the similar result to that produced by rule application based on the morphological analysis can be obtained.

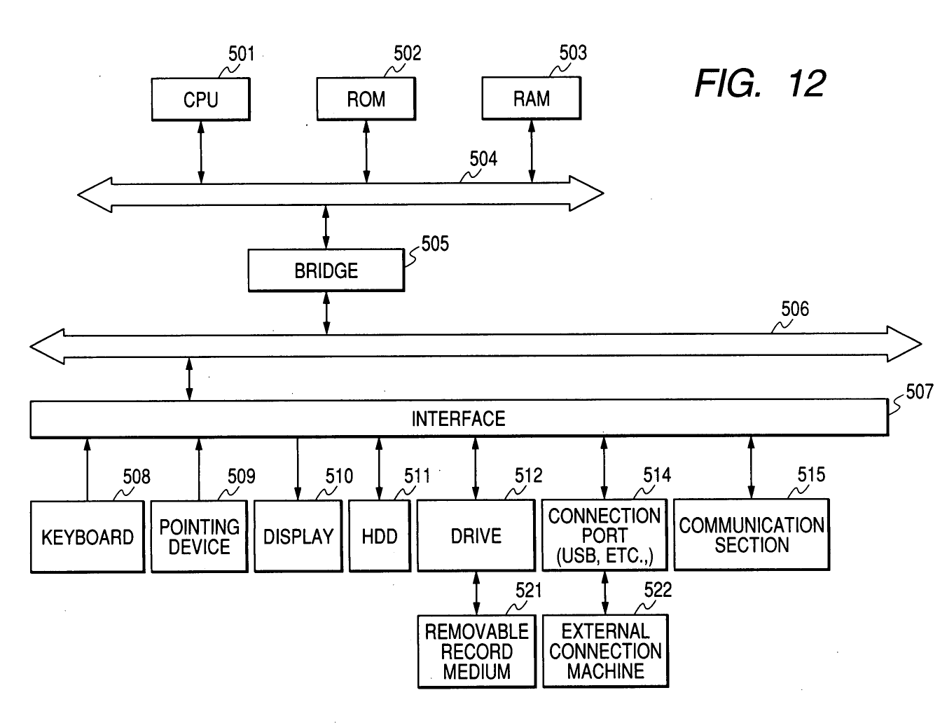

Last, a hardware configuration example of an information processing apparatus implementing the question answering system for executing the processing described above will be discussed with reference to FIG. 12. A CPU (Central Processing Unit) 501 executes a process corresponding to an OS (Operating System) and executes the feature word extraction, the search process, the query generation processing, the passage search process, the morphological analysis process, the answer candidate inspection processing, etc., based on an input question described above in the examples. The CPU 501 executes the processing in accordance with a computer program stored in a data storage section of ROM, a hard disk, etc., of each information processing apparatus.

ROM (Read-Only Memory) 502 stores the program, operation parameters, etc., used by the CPU 501. RAM (Random Access Memory) 503 stores a program used in execution of the CPU 501, parameters, etc., changed whenever necessary in the execution of the CPU 501. They are connected by a host bus 504 implemented as a CPU bus, etc.

The host bus 504 is connected to an external bus 506 of a PCI (Peripheral Component Interconnect/Interface) bus, etc., via a bridge 505.

A keyboard 508 and a pointing device 509 are input devices operated by the user. A display 510 is implemented as a liquid crystal display, a CRT (cathode ray tube), or the like for displaying various pieces of information as text or an image.

An HDD (Hard Disk Drive) 511 contains a hard disk and drives the hard disk for recording or reproducing (playing back) a program executed by the CPU 501 and information. The hard disk is used as answer candidate and passage storage means as the search result, storage means of the rules applied to combining of answer candidates applied in the answer candidate inspection unit, morphological analysis result storage means, answer candidate storage means, etc., for example, and further stores various computer programs such as a data processing program.

A drive 512 reads data or a program recorded on a removable record medium 521 such as a magnetic disk, an optical disk, a magneto-optical disk, or semiconductor memory mounted, and supplies the data or the program to the RAM 503 connected via the interface 507, the external bus 506, the bridge 505, and the host bus 504.

A connection port 514 is a port for connecting an external connection machine 522 and has a connection section of USB, IEEE 1394, etc. The connection port 514 is connected to the CPU 501, etc., via the interface 507, the external bus 506, the bridge 505, the host bus 504, etc. A communication section 515 is connected to a network for executing communications with a client and a network connection server.

The hardware configuration example of the information processing apparatus applied as the question answering system shown in FIG. 12 is an example of an apparatus incorporating a PC and the question answering system of the invention is not limited to the configuration shown in FIG. 12 and may have any configuration if the configuration has the capability of executing the processing described above in the examples.

While the invention has been described in detail in its preferred embodiment (examples), it is to be understood that modifications will be apparent to those skilled in the art without departing from the spirit and the scope of the invention. That is, the invention is disclosed for illustrative purposes only and it is to be understood that the invention is not limited to the specific embodiment (examples) thereof except as defined in the claims.

The processing sequence described in the specification can be executed by both or either of hardware and software. To execute software processing, the program recording the processing sequence can be installed in memory in a computer incorporated in dedicated hardware for execution or can be installed in a general-purpose computer that can execute various types of processing for execution.

For example, the program can be previously recorded on a hard disk or in ROM (Read-Only Memory) as a record medium or can be stored (recorded) temporarily or permanently on a removable record medium such as a flexible disk, a CD-ROM (Compact Disk Read-Only Memory), an MO (Magneto Optical) disk, a DVD (Digital Versatile Disk), a magnetic disk, or semiconductor memory. Such a removable record medium can be provided as a package software product.

The program not only can be installed in a computer from a removable record medium as described above, but also can be transferred by radio waves from a download site to a computer or can be transferred to a computer in a wired manner through a network such as the Internet for the computer to receive the program thus transferred and install the program on a record medium such as a hard disk incorporated.

The various types of processing described in the specification may be executed not only in time sequence according to the description, but also in parallel or individually in response to the processing capability of the apparatus for executing the processing or as required. The system in the specification is a logical set made up of a plurality of units (apparatus) and is not limited to a set of units (apparatus) housed in a single cabinet.

What is claimed is:

1. A question answering system comprising:
an answer candidate extraction unit that executes a search process based on an input question to extract a plurality of initial answer candidates;
a query generation unit that generates a query including at least two of the initial answer candidates as search words;
a passage search unit that executes a search process based on the query to extract search results corresponding to the query;
an answer candidate inspection unit that analyzes the hit sentence to inspect a relationship between the initial answer candidates and generates answer candidates to the input question on a basis of an inspection result; and
an answer output unit that outputs the answer candidates generated by the answer candidate inspection unit.

2. The question answering system according to claim 1, wherein the answer candidate inspection unit determines whether or not the initial answer candidates contain initial answer candidates handled as apposition, paraphrase, or parallel, and generates the answer candidates on a basis of a determination result.

3. The question answering system according to claim 2, wherein if the initial answer candidates contain the answer candidates handled as apposition, paraphrase, or juxtaposition, the answer candidate inspection unit executes at least one of a process of combining the answer candidates to generate a new answer candidate and a process of re-ranking the answer candidates, to generate the answer candidates.

4. The question answering system according to claim 1, further comprising:
a morphological analysis unit that executes a morphological analysis process of the hit sentence extracted by the passage search unit, wherein:
the answer candidate inspection unit determines whether or not a region containing initial answer candidates included in the hit sentence is based on a predetermined rule on a basis of an analysis result of the morphological analysis unit, and
if the region is based on the predetermined rule, the answer candidate inspection unit combines the initial answer candidates contained in the region to generate the answer candidates.

5. The question answering system according to claim 1, wherein:
the answer candidate inspection unit executes pattern matching on a basis of the initial answer candidates contained in the hit sentence extracted by the passage search unit, detects a region containing the initial answer candidates contained in the hit sentence, determines whether or not the detected region is based on a predetermined rule, and
if the region is based on the predetermined rule, the answer candidate inspection unit combines the initial answer candidates contained in the region to generate a answer candidate.

6. The question answering system according to claim 1, wherein:
the answer candidate extraction unit executes the search process based on the input question to extract sentences including the initial answer candidates, and
the passage search unit searching a set of passages including the sentences extracted by the answer candidate extraction unit.

7. The question answering system according to claim 1, wherein the passage search unit searches a knowledge source different from a knowledge source, which the answer candidate extraction unit searches based on the input question.

8. The question answering system according to claim 1, wherein:
the answer candidate inspection unit inspects whether or not the initial answer candidates contain synonymous answer candidates and handles the synonymous answer candidates as a group, and
the answer candidate inspection unit analyzes the hit sentence to inspect a relationship between the group of synonymous answer candidates and the other initial answer candidates, and generates the answer candidates to the input question on the basis of the inspection result.

9. The question answering system according to claim 1, further comprising:
a morphological analysis unit that executes a morphological analysis process of the initial answer candidates, which are of components of the query generated by the query generation unit, wherein:
the answer candidate inspection unit calculates a word overlap ratio of each query on a basis of an analysis result of the morphological analysis unit, sets score of each answer candidate on a basis of the calculated word overlap ratio, and determines an answer candidate ranking output as the answer candidates to the input question.

10. The question answering system according to claim 1, wherein:
the answer candidate inspection unit has a configuration to which a machine learning technique is applied, and
the answer candidate inspection unit updates a rule used in extracting of the answer candidates, on a basis of the machine learning technique.

11. A data search method comprising:
executing a search process based on an input question to extract a plurality of initial answer candidates;
generating a query including at least two of the initial answer candidates as search words;
executing a search process based on the query to extract a hit sentence corresponding to the query;
analyzing the hit sentence to inspect a relationship between the initial answer candidates;
generating answer candidates to the input question on a basis of a result of the inspecting; and
outputting the answer candidates generated.

12. The data search method according to claim 11, wherein:
the inspecting determines whether or not the initial answer candidates contain initial answer candidates handled as apposition, paraphrase, or juxtaposition, and
the generating of the answer candidates generates the answer candidates on a basis of a results of the determining.

13. The data search method according to claim 12 wherein if the initial answer candidates contain the answer candidates handled as apposition, paraphrase, or juxtaposition, the generating of the answer candidates executes at least one of a process of combining the answer candidates to generate a new answer candidate and a process of re-ranking the answer candidates to generate the answer candidates.

14. The data search method according to claim 11, further comprising
executing a morphological analysis process of the hit sentence extracted, wherein:
the inspecting determines whether or not a region containing initial answer candidates included in the hit sentence is based on a predetermined rule on a basis of a result of the morphological analysis process, the data search method further comprising:
if the region is based on the predetermined rule, the generating of the answer candidates combines the initial answer candidates contained in the region to generate the answer candidates.

15. The data search method according to claim 11, wherein:
the inspecting executes pattern matching on a basis of the initial answer candidates contained in the hit sentence extracted, detecting a region containing the initial answer candidates contained in the hit sentence, and determining whether or not the detected region is based on a predetermined rule, and
if the region is based on the predetermined rule, the inspecting further combines the initial answer candidates contained in the region to generate a answer candidate.

16. The data search method according to claim 11, wherein
the executing of the search process based on the input question executes the search process based on the input question to extract sentences including the initial answer candidates, and
the executing of the search process based on the query searches a set of passages including the sentences extracted by the answer candidate extraction unit.

17. The data search method according to claim 11, wherein the executing of the search process based on the query searches a knowledge source different from a knowledge source, which the executing of the search process based on the input question searches.

18. The data search method according to claim 11, wherein
the analyzing comprises:
inspecting whether or not the initial answer candidates contain synonymous answer candidates and handles the synonymous answer candidates as a group, and
analyzing the hit sentence to inspect a relationship between the group of synonymous answer candidates and the other initial answer candidates, wherein:
the generating of the answer candidates generates the answer candidates to the input question on the basis of a result of the inspecting the relationship.

19. The data search method according to claim 11, further comprising:
executing a morphological analysis process of the initial answer candidates, which are of components of the query generated by the query generation unit, wherein:
the analyzing comprises:
calculating a word overlap ratio of each query on a basis of a result of the morphological analysis process,
setting score of each answer candidate on a basis of the calculated word overlap ratio; and
determining an answer candidate ranking output as the answer candidates to the input question.

20. The data search method according to claim 11 wherein
the analyzing adopts a machine a machine learning technique, and
the analyzing comprises updating a rule used in extracting of the answer candidates, on a basis of the machine learning technique.

21. A computer program stored in a computer readable recording medium, the program causing a computer to execute a data search process comprising:
executing a search process based on an input question to extract a plurality of initial answer candidates;
generating a query including at least two of the initial answer candidates as search words;
executing a search process based on the query to extract a hit sentence corresponding to the query;
analyzing the hit sentence to inspect a relationship between the initial answer candidates;
generating answer candidates to the input question on a basis of a result of the inspecting; and
outputting the answer candidates generated.
